(19) United States
(12) Patent Application Publication
(10) Pub. No.: US 2025/0321427 A1
(43) Pub. Date: Oct. 16, 2025

(54) DISPLAY DISPARITY SENSOR, AND SYSTEMS AND METHODS OF USE THEREOF

(71) Applicant: Meta Platforms Technologies, LLC, Menlo Park, CA (US)

(72) Inventors: Kirk Erik Burgess, Newark, CA (US); Kevin Sawyer, Cupertino, CA (US)

(21) Appl. No.: 19/094,679

(22) Filed: Mar. 28, 2025

Related U.S. Application Data
(60) Provisional application No. 63/632,986, filed on Apr. 11, 2024.
(60) Provisional application No. 63/751,223, filed on Jan. 29, 2025.

(51) Int. Cl. G02B 27/01; G06T 19/00

(52) U.S. Cl. CPC G02B 27/0172; G06T 19/006; G02B 2027/0174

(57) ABSTRACT

An artificial-reality (AR) headset including a first holographic element that projects first focused light onto a first light detector and a second holographic element that projects second focused light onto a second light detector. The AR headset includes a first display coupled to the first holographic element, wherein the first display causes display of a first image, and a second display coupled to the second holographic element, where the second display causes display of a second image. The headset includes at least one display engine configured to receive respective calibration data from the first light detector and the second light detector; determine, based on comparing the respective calibration data, a disparity between the first display and the second display; and in accordance with a determination that the disparity between the first display and the second display satisfies disparity correction criteria generate an updated first image or updated second image.

### PRIORITY AND RELATED APPLICATIONS

This application claims priority to U.S. Provisional Patent App. No. 63/751,223, filed Jan. 29, 2025, and U.S. Provisional Patent App. No. 63/632,986, filed Apr. 11, 2024, which are hereby incorporated by reference in their entirety.

### TECHNICAL FIELD

This application relates generally to head-mounted displays (e.g., artificial-reality headsets) and more specifically to artificial-reality glasses, including but not limited to display disparity sensing systems for detecting and correcting display disparities between displays of artificial-reality glasses.

### BACKGROUND

In a binocular vision, vertical disparity between displays of artificial-reality glasses significantly affects user comfort. Due to various styles and designs of artificial-reality glasses frames, there may be constraints on mechanical design interventions that result in vertical disparity between displays beyond user comfort zone and lead to undesired issues such as increased eye strain and failure to fuse. Specifically, increased eye strain would restrict duration that a user can spend on displays. Furthermore, vertical disparity between displays would cause double vision as well as reduced image sharpness, exacerbating user experience with artificial-reality glasses.

As such, there is a need to address one or more of the above-identified challenges. A brief summary of solutions to the issues noted above are described below.

### SUMMARY

Addressing the aforementioned challenges specific to artificial-reality glasses requires solutions that take into account mechanical designs and binocular vision, alongside cost considerations. One solution is to correct disparities between displays by utilizing a display disparity sensor. In accordance with some embodiments, the display disparity sensor includes holographic optical elements that couple non-focused light from display waveguides onto light detectors. In some embodiments, each holographic optical element is configured to transform planar electromagnetic waves received from a corresponding display waveguide into a focused light beam that is incident onto the respective light detector.

Each holographic optical element is positionally fixed relative to a respective display waveguide and a respective light detector. In some embodiments, the light detectors are rigidly mounted to two separate displays of artificial-reality glasses, respectively. In some embodiments, each display waveguide has a corresponding output coupler that couples the waveguide mode toward the corresponding holographic optical element. In some embodiments, each holographic optical element focuses the light received from a corresponding output coupler and onto a corresponding light detector to generate display disparity calibration data. The display disparity calibration data corresponds to positional information of the focused light spot on the light detector. In some embodiments, a display engine (and/or processing element) compares the display disparity calibration data from each light detector to determine an amount of positional, angular, mechanical, and/or optical disparity between the two displays. For example, a focused light spot on a left light detector varies angularly from a focused light spot on a right light detector based on positional, angular, and/or mechanical misalignments between a left display assembly and a right display assembly of the artificial-reality glasses. In some embodiments, the focused light spot on the left light detector varies angularly from the focused light spot on the right light detector based on an optical disparity arising from mode propagation variations in the display waveguides of the artificial-reality glasses.

If an amount of disparity between the two displays satisfies a predetermined threshold, the display disparity system updates one or more images generated by at least one display engine of the artificial-reality glasses to correct for and/or reduce the amount of disparity. For example, a difference between the left display disparity readings and the right display disparity readings is used to correct one or more display images to satisfy the reprojection requirements.

In accordance with some embodiments, the display disparity sensor includes a focused light source (e.g., a laser or light-emitting diode) and a light sensor (e.g., an N by M detector array or pixel array) for detecting disparities (e.g., displacements) between displays in an arcmin level through power-based centroiding. In particular, the focused light source and the light sensor are rigidly mounted to two separate displays of artificial-reality glasses, respectively, and directed toward each other, which enables tracking of angular movement between the two displays by analyzing positional deviations of the focused light source's spot on the image sensor. The positional deviations are used to calibrate the disparities, and based on these calibrated disparities, images presented by the displays are updated such that misalignment between images is substantially reduced. In addition, displays of artificial-reality glasses units are calibrated during manufacturing to ensure that alignment between displays falls within specifications.

In accordance with some embodiments, an artificial-reality glasses unit includes a first display, a second display, one or more non-transitory computer-readable storage medium storing instructions, and one or more processors coupled to the storage medium. The one or more processors are configured to execute the instructions to perform operations. The operations include projecting an output light from a light emitter coupled to the first display to a light sensor coupled to the second display. The light emitter and the light sensor are positionally fixed relative to one another. The first display is configured to present a first image. The second display is configured to present a second image. The operations also include, by the light sensor, calibration image data that includes a representation of the output light from the light emitter. The operations further include determining, based on the calibration image data, a disparity between the first display and the second display. The operations further include in accordance with a determination that the disparity between the first display and the second display satisfies disparity correction criteria: updating the first image and/or the second image, based on the disparity between the first display and the second display, to form an updated first image and/or an updated second image, and presenting the updated first image and/or the updated second image via the first display and the second display, respectively. The updated first image and/or the updated second image are substantially aligned.

The features and advantages described in the specification are not necessarily all-inclusive and, in particular, certain additional features and advantages will be apparent to one of ordinary skill in the art in view of the drawings, specification, and claims. Moreover, it should be noted that the language used in the specification has been principally selected for readability and instructional purposes.

Having summarized the above example aspects, a brief description of the drawings will now be presented.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

For a better understanding of the various described embodiments, reference should be made to the Detailed Description below, in conjunction with the following drawings in which like reference numerals refer to corresponding parts throughout the figures.

FIG. 1 illustrates a system block diagram of an example architecture of artificial-reality glasses that includes disparity correction between displays, in accordance with some embodiments.

FIG. 2 illustrates a rigid tube for coupling a light emitter and a light sensor, in accordance with some embodiments.

FIG. 3 illustrates two example light-emitting component embodiments, in accordance with some embodiments.

FIG. 4 illustrates example calibration image data of disparity between displays of artificial-reality glasses using a display disparity sensor, in accordance with some embodiments.

FIG. 5 illustrates a flow diagram of an example method of correcting disparity between displays of artificial-reality glasses, in accordance with some embodiments.

FIGS. 6A, 6B, 6C-1, 6C-2, 6D-1, and 6D-2 illustrate example artificial-reality systems, in accordance with some embodiments.

FIGS. 7A and 7B illustrate an example wrist-wearable device, in accordance with some embodiments.

FIGS. 8A, 8B-1, 8B-2, and 8C illustrate example head-wearable devices, in accordance with some embodiments.

FIGS. 9A and 9B illustrate an example handheld intermediary processing device, in accordance with some embodiments.

FIG. 10 illustrates an example disparity sensor system for artificial-reality glasses, in accordance with some embodiments.

FIGS. 11A and 11B illustrate a flow diagram of an example method of correcting a disparity between displays of artificial-reality glasses, in accordance with some embodiments.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method, or device. Finally, like reference numerals may be used to denote like features throughout the specification and figures.

### DETAILED DESCRIPTION

Numerous details are described herein to provide a thorough understanding of the example embodiments illustrated in the accompanying drawings. However, some embodiments may be practiced without many of the specific details, and the scope of the claims is only limited by those features and aspects specifically recited in the claims. Furthermore, well-known processes, components, and materials have not necessarily been described in exhaustive detail so as to avoid obscuring pertinent aspects of the embodiments described herein.

Embodiments of this disclosure can include or be implemented in conjunction with various types or embodiments of artificial-reality systems. Artificial-reality (AR), as described herein, is any superimposed functionality and or sensory-detectable presentation provided by an AR system within a user's physical surroundings. Such artificial-realities can include and/or represent virtual reality (VR), artificial reality, mixed artificial-reality (MAR), or some combination and/or variation of one of these. For example, a user can perform a swiping in-air hand gesture to cause a song to be skipped by a song-providing API providing playback at, for example, a home speaker. An AR environment, as described herein, includes, but is not limited to, VR environments (including non-immersive, semi-immersive, and fully immersive VR environments); AR environments (including marker-based AR environments, markerless AR environments, location-based AR environments, and projection-based AR environments); hybrid reality; augmented-reality; and other types of mixed-reality environments.

AR content can include completely generated content or generated content combined with captured (e.g., real-world) content. The AR content can include video, audio, haptic events, or some combination thereof, any of which can be presented in a single channel or in multiple channels (such as stereo video that produces a three-dimensional effect to a viewer). Additionally, in some embodiments, artificial reality can also be associated with applications, products, accessories, services, or some combination thereof, which are used, for example, to create content in an artificial reality and/or are otherwise used in (e.g., to perform activities in) an artificial reality.

Terminology surrounding extended-reality devices can change, and as such this application uses terms that in some instances can be interchangeable with other terms. While not limiting in nature, some alternative definitions are included herein. This application uses the term “Artificial Reality” to be a catchall term covering virtual reality (VR), augmented reality, and mixed artificial reality (MAR); however, the term “extended-reality” can be used in place of “artificial reality” as a catchall term. The term augmented reality falls under the extended-reality catchall umbrella. The terms virtual-reality and mixed artificial reality, in some instances, can be replaced by the broader term “mixed-reality,” commonly referred to as “MR,” and also fall under the extended-reality catchall umbrella. This MR term is meant to cover all extended-reality experiences that do not include a direct viewing of the surrounding environment, which can include virtual reality as well as virtual-realities that have the surrounding environment presented to the user indirectly from data acquired from sensors of the device (e.g., SLAM cameras, cameras, ToF sensors, etc.). Augmented reality includes directly viewing the surrounding environment, e.g., through a waveguide or a lens.

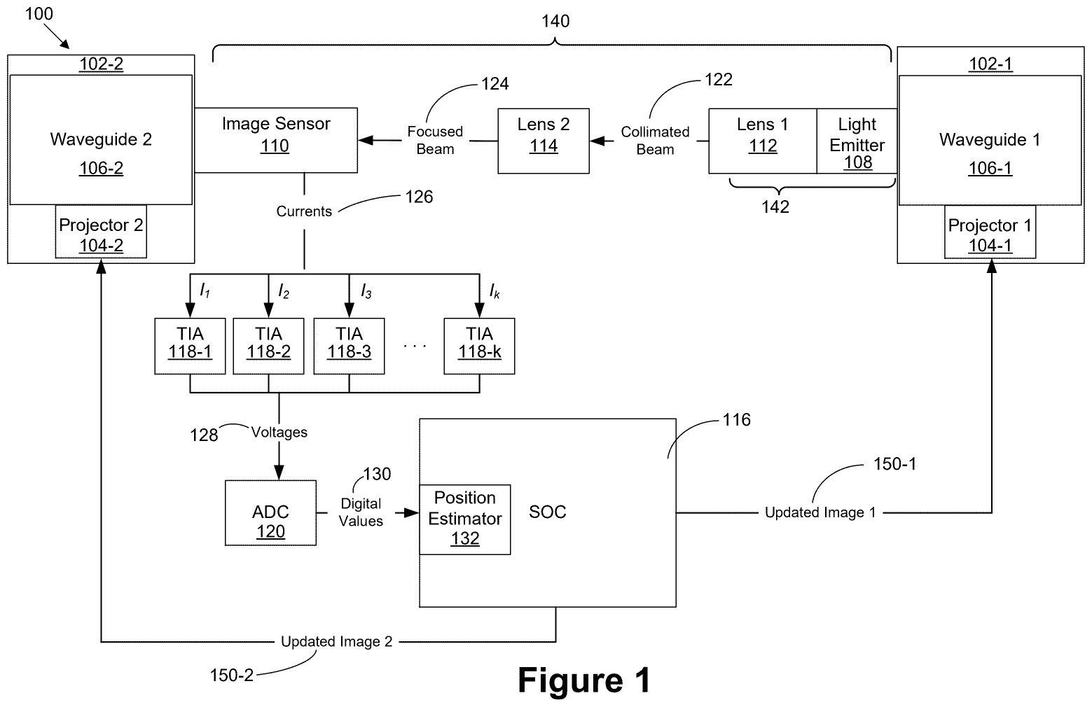

FIG. 1 illustrates a system block diagram 100 of an example architecture of AR glasses that includes disparity correction between displays, in accordance with some embodiments. The system block diagram 100 includes at least a display 102-1, a display 102-2, and a system-on-chip (SOC) 116. The displays 102-1 and 102-2 are electrically coupled to the SOC 116. The display 102-1 includes a projector 104-1 and a waveguide 106-1, and the display 102-2 includes a projector 104-2 and a waveguide 106-2. In some embodiments, the displays 102-1 and 102-2 include respective optical elements (not shown) or respective eye boxes (not shown) for presenting images to a user. The SOC 116 is configured to render AR content to generate a first image and a second image and send the first image to the projector 104-1 of the display 102-1 and the second image to the projector 104-2 of the display 102-2. The displays 102-1 and 102-2 are configured to present the first and second images via the waveguides 106-1 and 106-2, respectively. In some embodiments, the first and second images are presented through the respective optical elements or the respective eye boxes (not shown in FIG. 1) of the AR glasses.

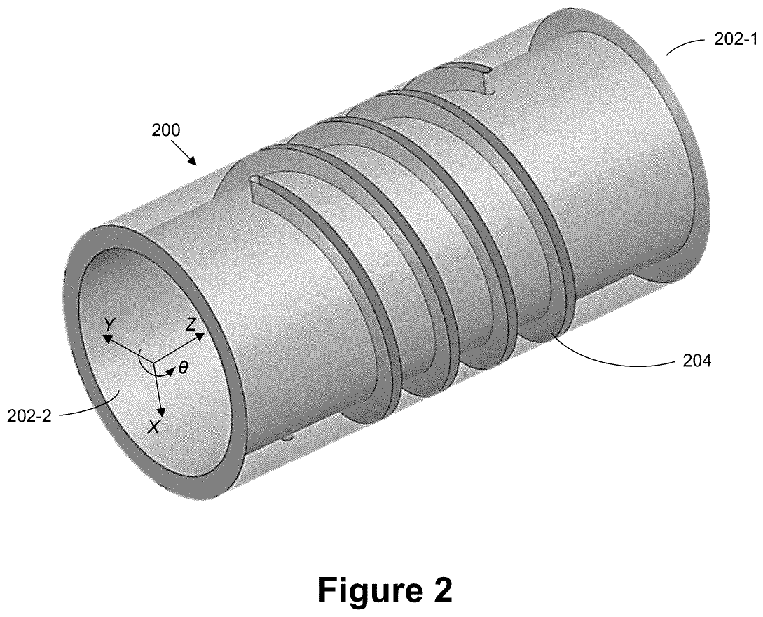

The system block diagram 100 further includes a display disparity sensor 140. The display disparity sensor 140 includes a light emitter 108, a light sensor 110, a lens 112, and a lens 114. The light emitter 108 and the lens 112 form a light-emitting component 142. The light emitter 108 is coupled to the display 102-1, and the light sensor 110 is coupled to the display 102-2. In some embodiments, the light emitter 108 is coupled to the waveguide 106-1 of the display 102-1, and the light sensor 110 is coupled to the waveguide 106-2 of the display 102-2. The light emitter 108 and the light sensor 110 are positionally fixed relative to one another, such that a measured disparity is between the displays 102-1 and 102-2 (e.g., the waveguide 106-1 of the display 102-1 and the waveguide 106-2 of the display 102-2). The positionally fixed positions between the light emitter 108 and the light sensor 110 allow for the light emitted via the light-emitting component 142 to be measured and used to detect and measure the disparity between the displays 102-1 and 102-2, as discussed below. As discussed in detail below in reference to FIG. 2, in some embodiments, the light emitter 108 and the light sensor 110 are coupled via a rigid tube 200.

In some embodiments, the light emitter 108 is a laser or a light-emitting diode. In some embodiments, the light emitter 108 is a vertical-cavity surface-emitting laser (VCSEL). In some embodiments, the light emitter 108 is electrically coupled to the SOC 116 via the display 102-1. In some embodiments, the light sensor 110 is a photodiode array including an N times M (N-by-M) array of photodiodes, where N and M are integers. In one example, the light sensor 110 is a four-quadrant silicon photodiode (e.g., a 2-by-2 silicon photodiode array). The light sensor 110 is electrically coupled to the SOC 116 via the display 102-2 and/or one or more transimpedance amplifiers 118 (discussed below). An output of the light sensor 110 is provided to the SOC 116 to determine the disparity between the displays 102-1 and 102-2. In some embodiments, the disparity between the displays 102-1 and 102-2 is captured in a two-dimensional matrix describing the disparity in angle degrees. Specifically, the two-dimensional matrix of the disparity between the displays 102-1 and 102-2 is a measurement in units of arcminutes (arcmins) with respect to field of view of the AR glasses.

As described above, the display disparity sensor 140 includes the lens 112 and the lens 114. An output light from the light emitter 108 is collimated by the lens 112 (e.g., a collimating lens) to form a collimated beam 122. The collimated beam 122 is further focused by the lens 114 (e.g., a focusing lens) to form a focused beam 124, which is projected onto the N-by-M array of the light sensor 110. The lens 114 is configured to remove translations in the collimated beam 122. In some embodiments, the lens 114 is embedded within the rigid tube 200 (discussed below in reference to FIG. 2). The rigid tube 200 can be optional.

The system block diagram 100 further includes one or more transimpedance amplifiers 118 (e.g., 118-1, 118-2, 118-3, . . . , 118-k) that are electrically coupled to the light sensor 110. Each transimpedance amplifier corresponds a respective photodiode of the N-by-M array of the light sensor 110. The system block diagram 100 further includes an analog-to-digital converter (ADC) 120, which is electrically coupled to the one or more transimpedance amplifiers 118-1 to 118-k and the SOC 116. In particular, the ADC 120 is coupled to a position estimator 132, which is part of the SOC 116. The position estimator 132 and the SOC 116 are configured to determine whether the disparity between the displays 102-1 and 102-2 satisfies disparity correction criteria.

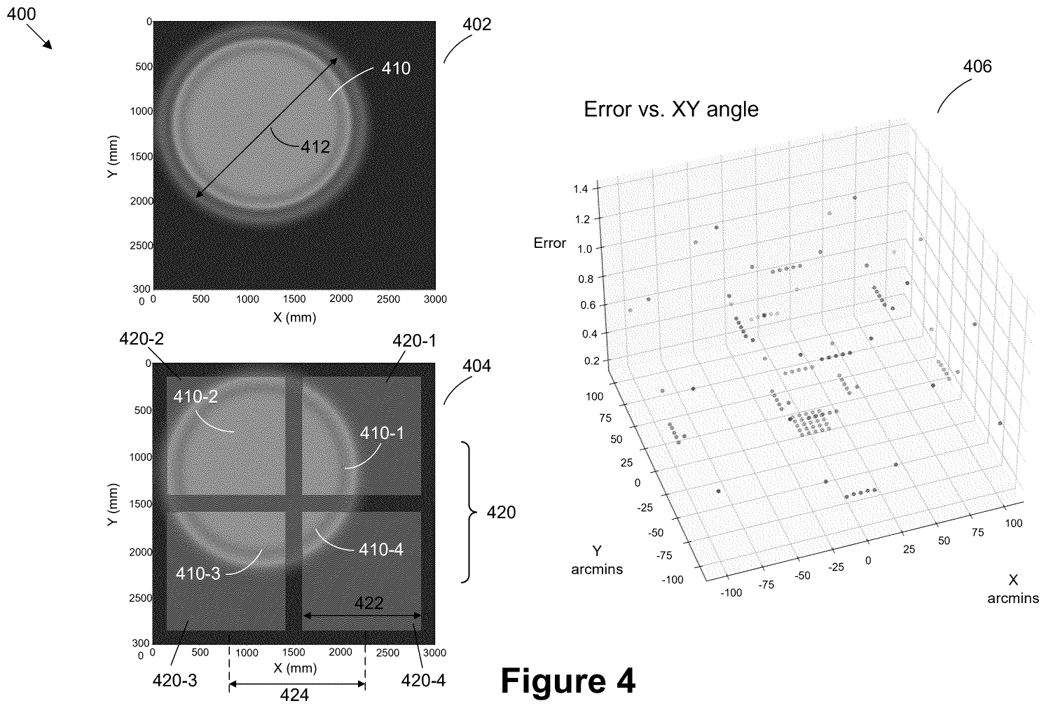

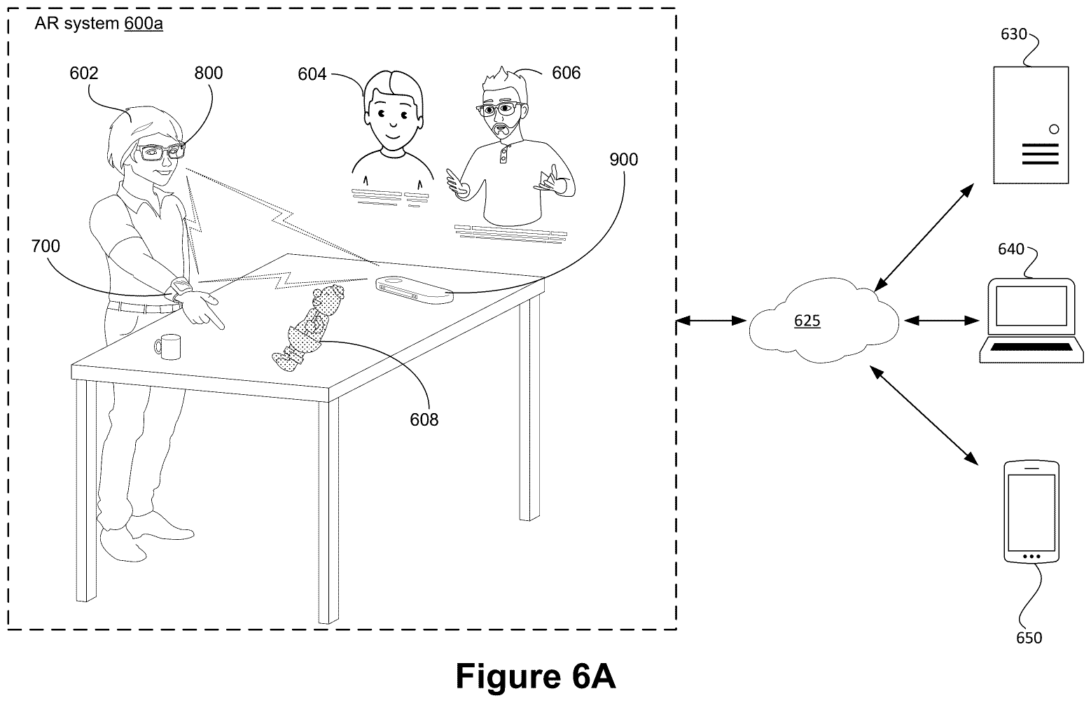

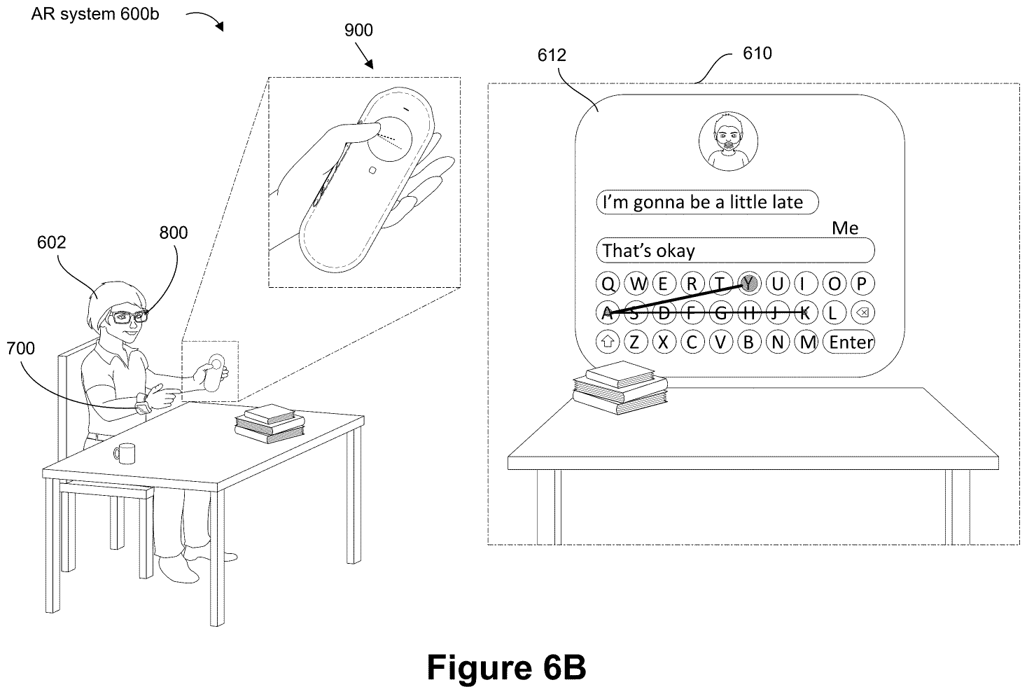

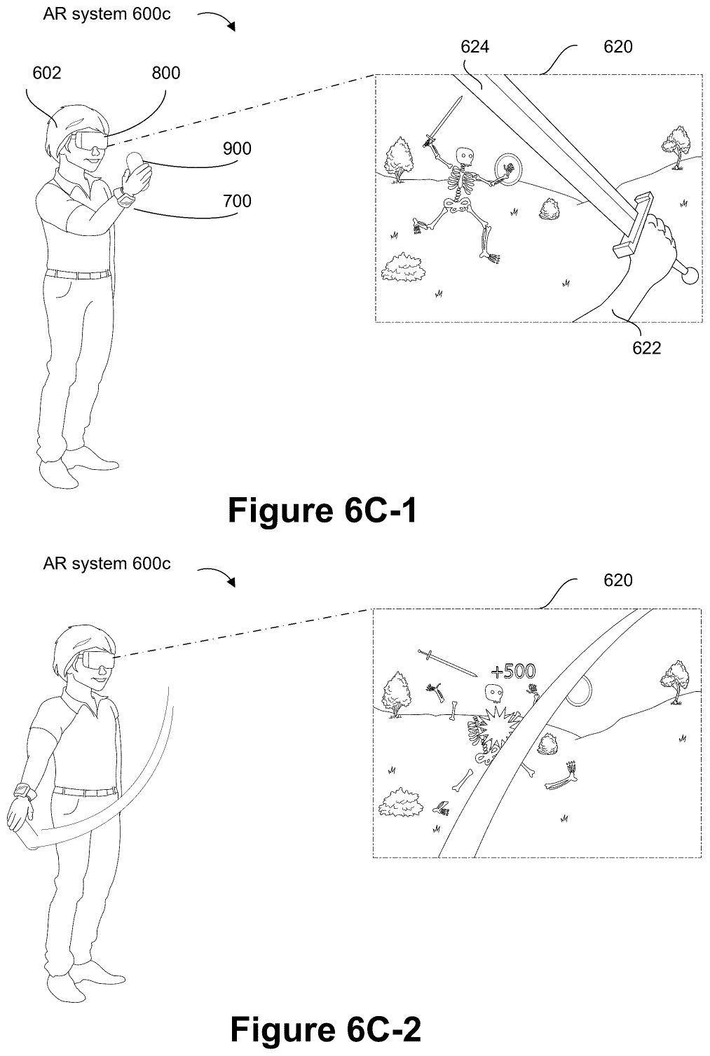

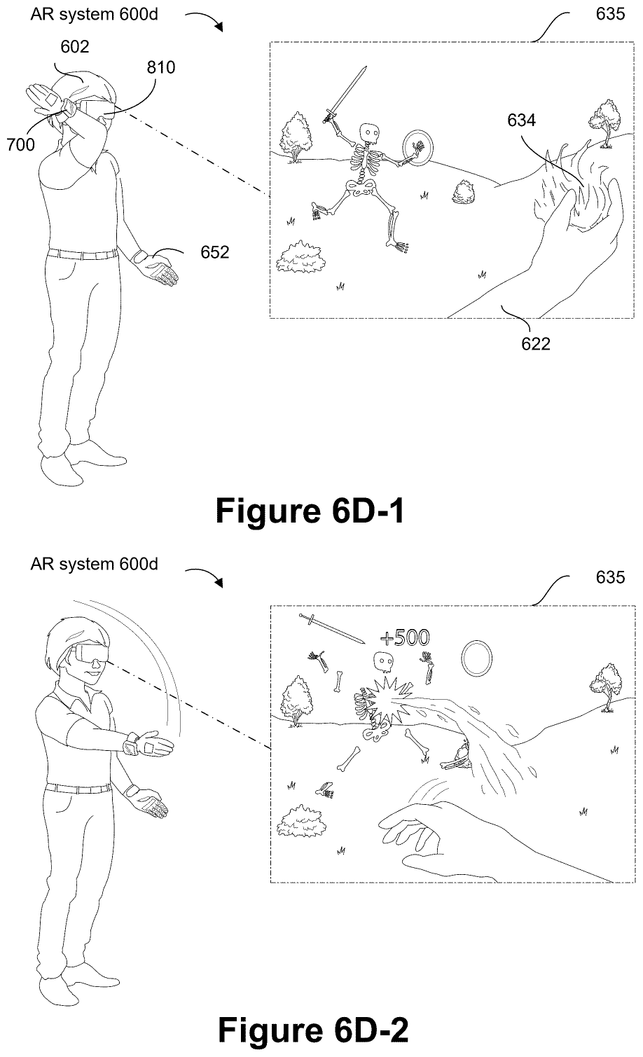

A process of correcting the disparity between the displays 102-1 and 102-2 is discussed generally below. The process of correcting the disparity can be performed by the AR glasses and/or another device communicatively coupled with the AR glasses (such as a mobile device, a handheld intermediary processing device, a computer, and/or any other device described below in reference to FIG. 6A). The process of correcting the disparity between the displays 102-1 and 102-2 includes projecting an output light from the light emitter 108 of the AR glasses to the light sensor 110. The process of correcting the disparity between the displays 102-1 and 102-2 also includes capturing, by the light sensor 110, calibration image data (discussed below in reference to FIG. 4) that includes a representation of the output light from the light emitter 108. For example, as shown in FIG. 1, the output light from the light emitter 108 is passed through the lens 112 to form the collimated beam 122, the collimated beam 122 is passed through the lens 114 to form the focused beam 124, and the focused beam 124 is captured by the light sensor 110 to generate the calibration image data.

The calibration image data corresponds to relative position shifts between the light emitter 108 and the light sensor 110. In some embodiments, the calibration image data is used to determine a power distribution (e.g., light intensity) of the captured representation (e.g., light spot) of the output light from the light emitter 108. The power distribution is presented in a two-dimensional matrix. The calibration image data is converted into currents 126 (e.g., I1, I2, I3, . . . , Ik) via the light sensor 110, where each current corresponds to a respective portion of the N-by-M array of the light sensor 110. The currents 126 (e.g., I1, I2, I3, . . . , Ik) are further converted to voltages 128 via transimpedance amplifiers 118-1 to 118-k, respectively, and the voltages 128 are further converted to corresponding digital values 130 via the ADC 120. The digital values 130 are sent to the position estimator 132 of the SOC 116.

The process of correcting the disparity between the displays 102-1 and 102-2 further includes determining, based on the calibration image data, the disparity between the displays 102-1 and 102-2. The position estimator 132 of the SOC 116 calculates the disparity between the displays 102-1 and 102-2 based on the digital values 130 that are associated with the calibration image data. The SOC 116 compares the digital values 130 with disparity correction criteria to determine whether the disparity correction criteria are satisfied. In accordance with a determination that the disparity between the displays 102-1 and 102-2 satisfies the disparity correction criteria, the AR glasses are configured to update the first image and/or the second image, based on the disparity between the displays 102-1 and 102-2, to form an updated image 150-1 and/or an updated image 150-2. In some embodiments, the same AR content is rendered by the SOC 116 to form the first and second images as well as the updated images 150-1 and 150-2.

The AR glasses are further configured to present the updated image 150-1 and/or the updated image 150-2 via the display 102-1 and the display 102-2, respectively, such that the updated image 102-1 and/or the updated image 102-2 are substantially aligned. Specifically, display artifacts associated with binocular vision (e.g., image misalignment, double-vision image sharpness, binocular fusion, etc.) at the respective eye boxes of the AR glasses are substantially reduced in accordance with display specifications of the AR glasses. In other words, the updated image 102-1 and/or the updated image 102-2 compensate for the disparity between the displays 102-1 and 102-2.

In some embodiments, the disparity correction criteria include prestored disparity calibration data that are determined by design specifications of the AR glasses, including mechanical designs of the AR glasses (e.g., vertical disparity) and binocular vision (e.g., image misalignment, double-vision image sharpness, binocular fusion, etc.). In some embodiments, the prestored disparity calibration data are stored in forms of look-up tables in memory of the SOC 116 and assessed by the position estimator 132 of the SOC 116. In some embodiments, the prestored disparity calibration data are stored in forms of digital codes, which are calibrated in accordance with the design specifications of the AR glasses during manufacturing.

In some embodiments, before projecting the output light from the light emitter 108, the AR glasses are configured to detect one or more misalignment correction events. In particular, each misalignment correction event corresponds to a request to correct image misalignment of a binocular vision resulting from the disparity between the displays 102-1 and 102-2. In some embodiments, the misalignment correction events include one or more of a predetermined period, donning and/or doffing AR glasses, and a detected impact at the AR glasses. For example, one or more misalignment correction events can be triggered per frame or every 1 millisecond (ms), such that the disparity between the displays 102-1 and 102-2 is captured and compensated on a per frame basis or a constant time basis, respectively. In another instance, the misalignment correction events include presentation of a distinct frame of a respective AR content or a distinct display mode. In yet another instance, the misalignment correction events include taking the AR glasses off and dropping the AR glasses.

FIG. 2 illustrates a rigid tube 200 for coupling the light emitter 108 and the light sensor 110, in accordance with some embodiments. The rigid tube 200 can be used with display disparity sensors (e.g., the display disparity sensor 140; FIG. 1). The rigid tube 200 includes a widthwise portion along an X-Y plane and a lengthwise portion along a Z axis. The rigid tube 200 further includes a side 202-1 and a side 202-2. The side 202-1 of the rigid tube 200 is configured to couple to the light emitter 108, and the side 202-2 of the rigid tube 200 is configured to couple to the light sensor 110. The rigid tube 200 is configured to keep the light emitter 108 and the light sensor 110 positionally fixed relative to one another as described above in reference to FIG. 1. In some embodiments, the side 202-1 of the rigid tube 200 is configured to couple to the waveguide 106-1 of the display 102-1 and the side 202-2 of the rigid tube 200 is configured to couple to the waveguide 106-2 of the display 102-2, such that the disparity between the displays 102-1 and 102-2 is only relative to the waveguides 106-1 and 106-2. In some embodiments, the rigid tube 200 includes the lens 114 that focuses the output light from the light emitter 108 to the light sensor 110.

In some embodiments, the rigid tube 200 includes a double helix flexure 204. The double helix flexure 204 is designed to flex and twist when subjected to external forces, which allows controlled movements while maintaining stiffness in X and Y directions and softness in X, Y, Z, and θ directions. In particular, the rigid tube 200 with the double helix flexure 204 provides both flexibility and stiffness to withstand a certain level of the disparity between the displays 102-1 and 102-2. In some embodiments, the rigid tube 200 is embedded within a nose portion of the AR glasses (e.g., a bridging portion of AR glasses frames that connects the displays 102-1 and 102-2).

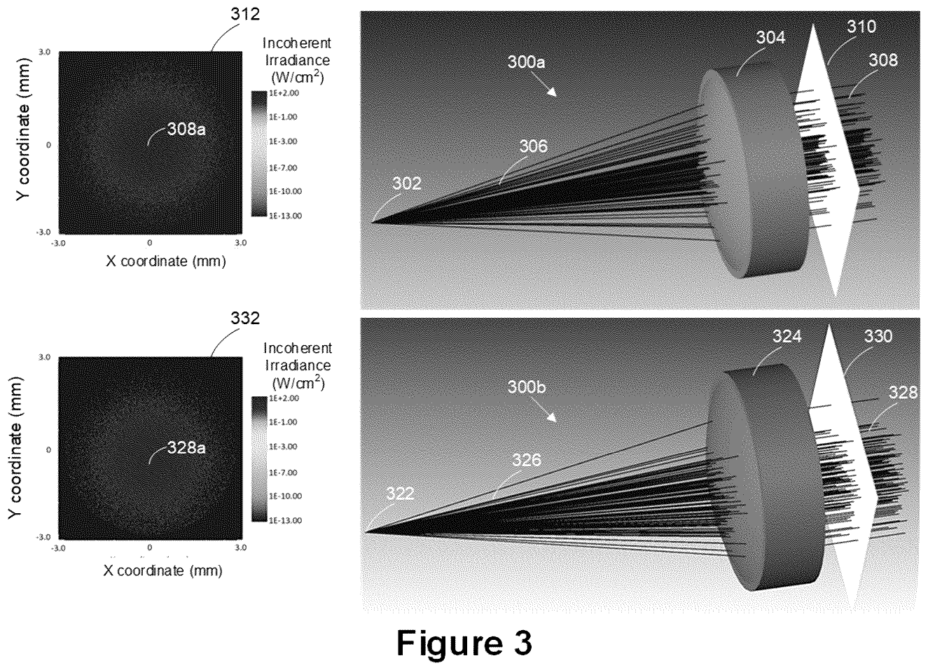

FIG. 3 illustrates two example light-emitting component embodiments, in accordance with some embodiments. The example light-emitting component embodiments can be used with light-emitting components of display disparity sensors (e.g., the light-emitting component 142 of the display disparity sensor 140 described above in reference to FIG. 1). FIG. 3 shows perspective views of the light-emitting component embodiments 300a and 300b and their corresponding collimated beams obtained from optical simulations.

The example light-emitting component embodiment 300a includes at least a light emitter 302 and a collimating lens 304. The light emitter 302 is a laser diode with a fan angle of 16 degrees. The collimating lens 304 is a D-ZK3 aspheric lens with a diameter of 6.325 mm, a focal length (f) of 11.0 mm, and a numeric aperture (NA) of 0.20. An output light 306 is projected from the light emitter 302 and further collimated by the collimating lens 304, forming a collimated beam 308. In the optical simulations, a cross-section 308a of the collimated beam 308 is detected by a 6 mm×6 mm detector 310 with a pixel size 250×250, as illustrated in an irradiance image plot 312. A total number of rays that hit the 6 mm×6 mm detector 310 is 99,839. As shown in the irradiance image plot 312, the collimated beam 308 remains Gaussian and has a total power of 0.99839 Watts and a peak irradiance of 4.3403×101 Watt/cm2.

Similar to the light-emitting component embodiment 300a, the light-emitting component embodiment 300b also includes at least a light emitter 322 and a collimating lens 324. The light emitter 322 is also a laser diode with a fan angle of 16 degrees. The collimating lens 324 may be a D-ZK3 aspheric lens with a diameter of 6.325 mm, a focal length (f) of 11.0 mm, and a numeric aperture (NA) of 0.20. An output light 326 is projected from the light emitter 322 and further collimated by the collimating lens 324, forming a collimated beam 328. In the optical simulations, a cross-section 328a of the collimated beam 328 is detected by a 6 mm×6 mm detector 330 with a pixel array of 250×250, as illustrated in an irradiance image plot 332. A total number of rays that hit the 6 mm×6 mm detector 310 is 99,759. As shown in the irradiance image plot 332, the collimated beam 328 remains Gaussian and has a total power of 0.99759 Watts and a peak irradiance of 4.5139×101 Watt/cm2.

As shown in FIG. 3, the collimated beams 308 and 328 are roughly retained in an area of 6 mm×6 mm. Specifically, without a focus lens (e.g., the lens 114 in reference to FIG. 1) being included in a respective display disparity sensor (e.g., the display disparity sensor 140 in reference to FIG. 1), a corresponding light sensor requires a detecting area of about 6 mm×6 mm to cover the collimated beams 308 and 328. On the other hand, with a focus lens being included in the respective display disparity sensor, the corresponding light sensor may require a lesser detecting area.

In some embodiments, choices of light emitters and collimating lens can vary, subject to the design specifications (e.g., optical requirements) of the AR glasses and associated display disparity sensors.

FIG. 4 illustrates example calibration image data of disparity between displays of the AR glasses using a display disparity sensor, in accordance with some embodiments. In the example calibration image data 400, an example display disparity sensor includes a laser diode (an instance of light emitter 108; FIG. 1) and a four-quadrant light sensor 420 (e.g., a four-quadrant silicon photodiode; an instance of light sensor 110 (FIG. 1)). Irradiance image plots 402 and 404 illustrate an off-centered incident beam 410 (e.g., a representation of an output light from the laser diode (not shown)) before and after being projected onto the four-quadrant light sensor 420, respectively. Moreover, a three-dimensional error plot 406 illustrates determined disparity in X-Y between displays of the AR glasses via the example display disparity sensor (analogous to the display disparity sensor 140; FIG. 1). In some embodiments, the off-centered incident beam 410 is a collimated beam or a focused beam depending on whether a focus lens is included in the example display disparity sensor.

The irradiance image plot 402 illustrates that the off-centered incident beam 410 remains Gaussian with a beam diameter 412 of about 2 mm. On the other hand, the irradiance image plot 404 shows the off-centered incident beam 410 after being projected onto the four-quadrant light sensor 420. The four-quadrant light sensor 420 is a four-quadrant silicon photodiode with a 2-by-2 array (e.g., a first to fourth 420-1 to 420-4), where each quadrant section is about 1.25 mm and each quadrant pitch is about 1.4 mm. As shown in the irradiance image plot 404, the off-centered incident beam 410 is off centered toward the quadrant 410-2 with respect to a center location of the four-quadrant light sensor 420 due to the disparity between displays. In particular, the disparity between displays corresponds to relative position shifts of the off-centered incident beam 410 between the laser diode and the four-quadrant light sensor 420 of the example display disparity sensor.

As further illustrated in the irradiance image plot 404, the off-centered incident beam 410 is separated into four portions (e.g., portions 410-1 to 410-4, based on the four quadrants of the four-quadrant light sensor 420). As shown in the irradiance image plot 404, the portion 410-2 of the off-centered incident beam 410 has a largest area among the four portions 410-1 to 410-4. The four-quadrant light sensor 420 is configured to capture calibration image data associated with the relative position shifts of the off-centered incident beam 410 between the laser diode and the four-quadrant light sensor 420 (e.g., shifts from the center location of the four-quadrant light sensor 420) to detect the disparity between displays. As discussed above, the calibration image data is used to describe a power distribution (e.g., light intensity) of the off-centered incident beam 410 in a two-dimensional matrix. Specifically, the calibration image data captured by the four-quadrant light sensor 420 is converted to four photocurrents, where each photocurrent corresponds to absorbed power of a respective quadrant (e.g., 420-1 to 420-4) of the four-quadrant light sensor 420. The four photocurrents that correspond to the four quadrants 420-1 to 420-4 are further converted to digital values via transimpedance amplifiers and an ADC (e.g., ADC 120; FIG. 1). The digital values are provided to the SOC 116 (FIG. 1) for determining the disparity between displays.

The three-dimensional error plot 406 illustrates the determined disparity in X-Y between displays according to the relative position shifts resulting from the off-centered incident beam 410. An X axis and a Y axis of the three-dimensional error plot 406 represent the disparity between displays along X and Y directions, respectively, in unit of arcminute (arcmin), while a Z axis of the three-dimensional error plot 406 represents an error.

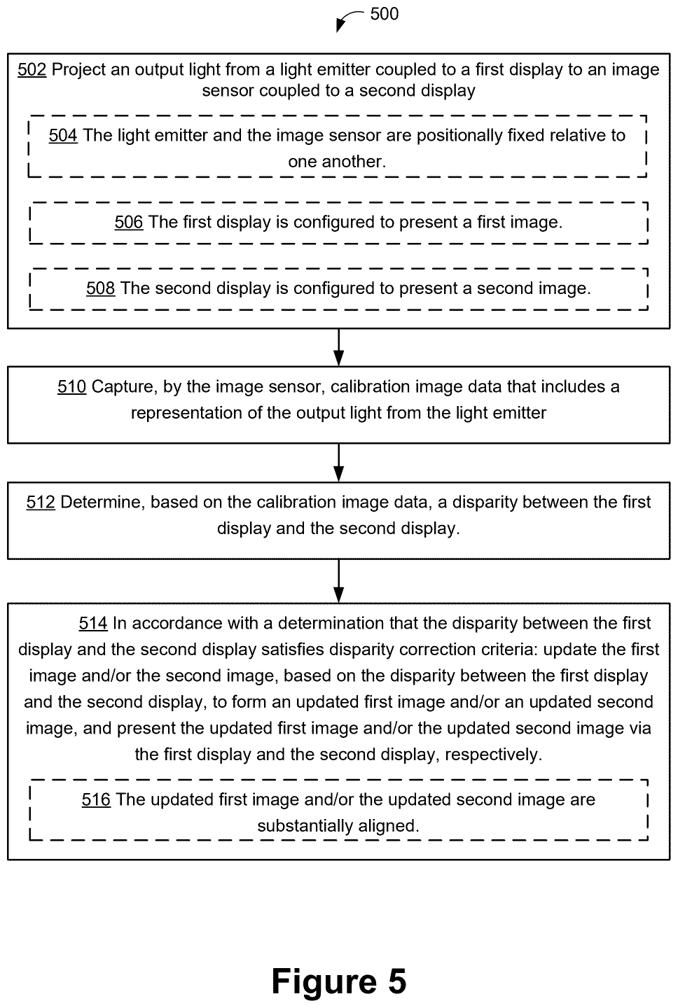

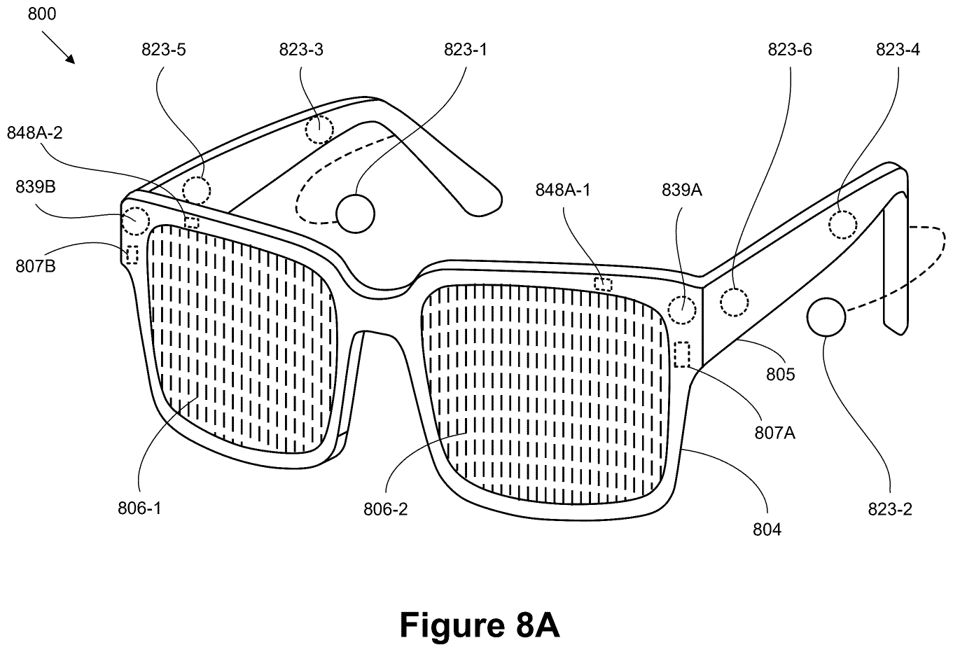

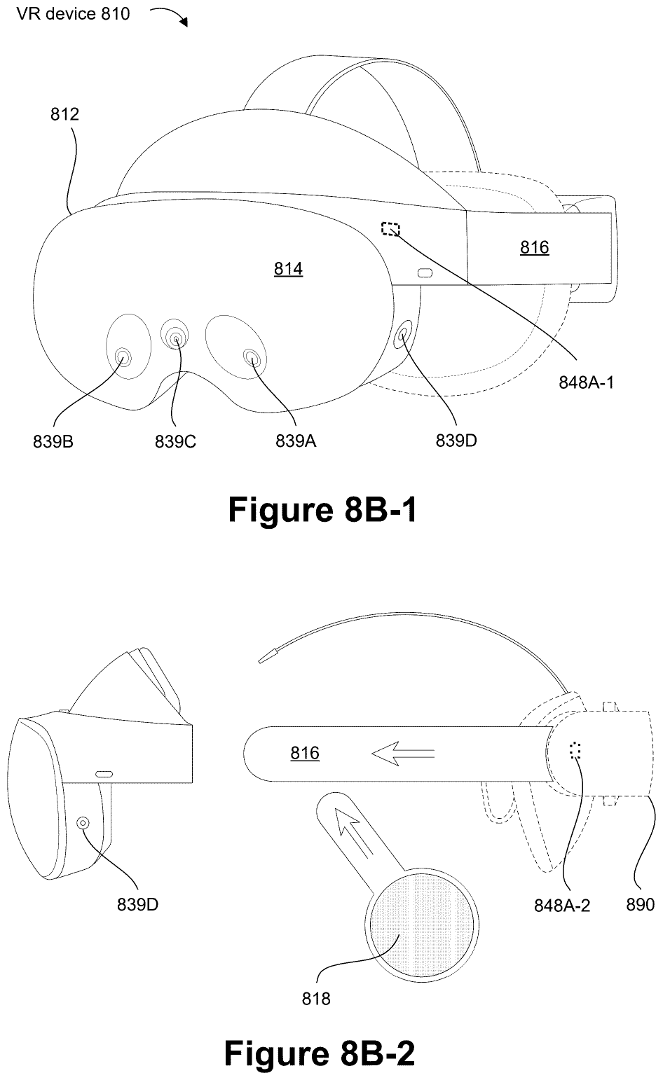

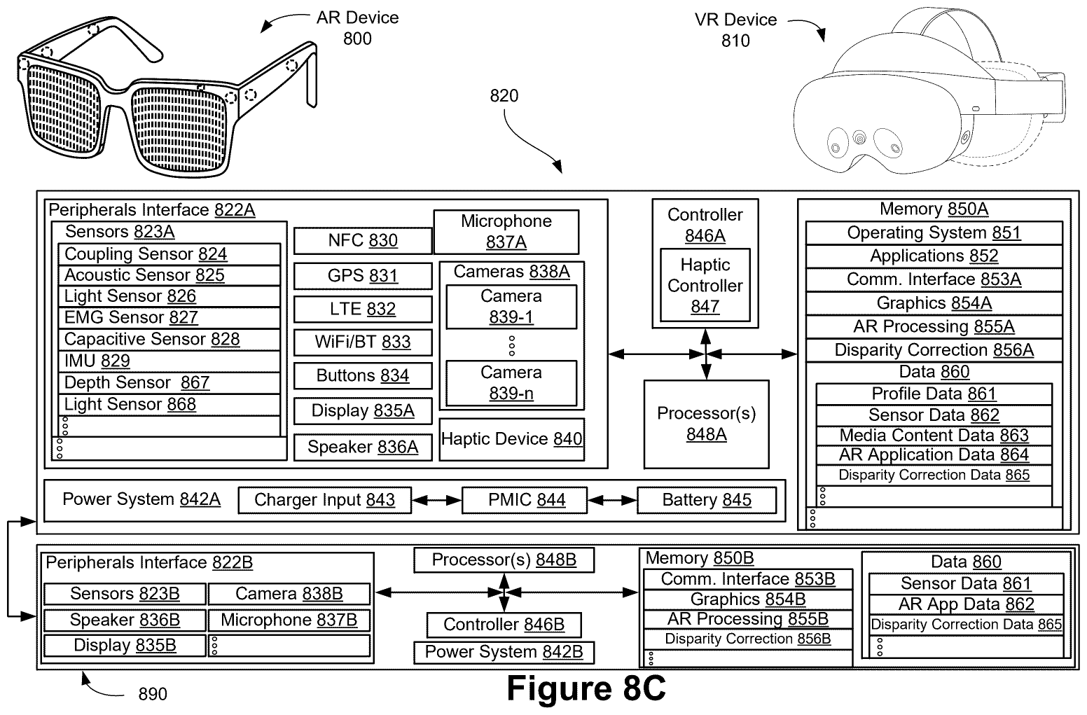

FIG. 5 illustrates a flow diagram of an example method 500 of correcting disparity between displays of AR glasses, in accordance with some embodiments. Specifically, the flow diagram of FIG. 5 can be used to correct disparity between displays (e.g., a display 102-1 and a display 102-2) based on a display disparity sensor described above in reference to FIGS. 1 to 4. Operations (e.g., steps) of the method 500 can be performed by one or more processors (e.g., central processing unit and/or microcontroller unit) of a head-wearable device (e.g., AR glasses or a VR headset) or a system including the head-wearable device and at least one other communicatively coupled device (e.g., a handheld intermediary processing device 900, a server 630, a computer 640, a mobile device 650, and/or other electronic devices described below in reference to FIG. 6A). At least some of the operations shown in FIG. 5 correspond to instructions stored in a computer memory or computer-readable storage medium (e.g., storage, random access memory, and/or other types of memory; e.g., memory 850 (FIG. 8C)). Operations of the method 500 can be performed by a single device alone (e.g., the head-wearable device) or in conjunction with one or more processors and/or hardware components of another communicatively coupled device (e.g., a handheld intermediary processing device 900) and/or instructions stored in memory or computer-readable medium of the other device communicatively coupled to the system. In some embodiments, the various operations of the methods described herein are interchangeable and/or optional, and respective operations of the methods are performed by any of the aforementioned devices, systems, or combination of devices and/or systems. For convenience, the method operations will be described below as being performed by particular component or device, but should not be construed as limiting the performance of the operation to the particular device in all embodiments.

(A1) The method 500 includes projecting (502) an output light from a light emitter coupled to a first display to a light sensor coupled to a second display. The light emitter and the light sensor are (504) positionally fixed relative to one another. The first display is (506) configured to present a first image. The second display is (508) configured to present a second image. The method 500 also includes capturing (510), by the light sensor, calibration image data that includes a representation of the output light from the light emitter. The method 500 also includes determining (512), based on the calibration image data, a disparity between the first display and the second display. The method 500 further includes in accordance with a determination that the disparity between the first display and the second display satisfies disparity correction criteria: updating (514) the first image and/or the second image, based on the disparity between the first display and the second display, to form an updated first image and/or an updated second image, and presenting the updated first image and/or the updated second image via the first display and the second display, respectively. The updated first image and/or the updated second image are (516) substantially aligned.

(A2) In some embodiments of A1, determining the disparity between the first display and the second display further includes comparing the calibration image data with prestored disparity calibration data. For instance, as described above in reference to FIG. 1, the SOC 116 receives and compares the digital values 130 with the disparity correction criteria to determine whether the disparity correction criteria are satisfied.

(A3) In some embodiments of A1-A2, the method 500 further includes, before projecting the output light from the light emitter, detecting one or more misalignment correction events. For instance, as described above in reference to FIG. 1, the event can correspond to a request to correct image misalignment of a binocular vision resulting from the disparity between the displays 102-1 and 102-2.

(A4) In some embodiments of A1-A3, the misalignment correction events include one or more of a predetermined time period, donning and/or doffing artificial-reality glasses, and a detected impact at the artificial-reality glasses. For instance, as described above in reference to FIG. 1, the predetermined time period can be related to a frame rate or a constant time period.

(A5) In some embodiments of A1-A4, the disparity between the first display and the second display is a two-dimensional matrix in angle degrees. For instance, as described above in reference to FIG. 4, the three-dimensional error plot 406 illustrates the determined disparity in X-Y between displays according to the relative position shifts resulting from the off-centered incident beam 410.

(A6) In some embodiments of A1-A5, the light emitter is a laser or a light-emitting diode. For instance, as described above in reference to FIG. 3, the light emitter 302 is a laser diode, and the example light emitter 322 is also a laser diode.

(A7) In some embodiments of A1-A6, the light sensor is a photodiode comprising an N times M photodiode array, N and M being integers. For instance, as described above in reference to FIG. 4, the four-quadrant light sensor 420 is a four-quadrant silicon photodiode with a 2-by-2 array (e.g., photodiodes 420-1 to 420-4), where each quadrant size is about 1.25 mm and quadrant pitch is about 1.4 mm.

(A8) In some embodiments of A1-A7, the output light from the light emitter is collimated by a first lens coupled to the first display. For instance, as described above in reference to FIG. 1, the output light from the light emitter 108 is collimated by the lens 112 (e.g., a collimating lens) to form a collimated beam 122. In another instance, as described above in reference to FIG. 3, the output light 306 is projected from the light emitter 302 and further collimated by the collimating lens 304, forming the collimated beam 308.

(A9) In some embodiments of A1-A8, the light emitter and the light sensor are coupled via a rigid tube. For instance, as described above in reference to FIG. 2, the side 202-1 of the rigid tube 200 is configured to couple to the light emitter 108, and the side 202-2 of the rigid tube 200 is configured to couple to the light sensor 110.

(A10) In some embodiments of A1-A9, the rigid tube includes a second lens that focuses the output light from the light emitter to the light sensor. For instance, as described above in reference to FIG. 1, the collimated beam 122 is further focused by the lens 114 (e.g., a focusing lens) to form the focused beam 124, which is projected onto the N-by-M photodiode array of the light sensor 110.

(B1) In accordance with some embodiments, a system that includes an artificial-reality headset (also referred to as a head-wearable device) and at least one electronic device, and the system is configured to perform operations corresponding to any of A1-A10.

(C1) In accordance with some embodiments, a non-transitory computer-readable storage medium including instructions that, when executed by a computing device in communication with an artificial-reality headset, cause the computer device to perform operations corresponding to any of A1-A10.

(D1) In accordance with some embodiments, an artificial-reality headset configured in accordance with FIG. 1 and configured to perform or cause the performance of the operations corresponding to any of A1-A10.

(E1) In accordance with some embodiments, a means for operating an artificial reality headset, means for performing operations that correspond to any of A1-A10.

The devices described above are further detailed below, including systems, wrist-wearable devices, headset devices, and smart textile-based garments. Specific operations described above may occur as a result of specific hardware, such hardware is described in further detail below. The devices described below are not limiting and features on these devices can be removed or additional features can be added to these devices. The different devices can include one or more analogous hardware components. For brevity, analogous devices and components are described below. Any differences in the devices and components are described below in their respective sections.

As described herein, a processor (e.g., a central processing unit (CPU) or microcontroller unit (MCU)), is an electronic component that is responsible for executing instructions and controlling the operation of an electronic device (e.g., a wrist-wearable device 700, a head-wearable device, an HIPD 900, or other computer system). There are various types of processors that may be used interchangeably or specifically required by embodiments described herein. For example, a processor may be (i) a general processor designed to perform a wide range of tasks, such as running software applications, managing operating systems, and performing arithmetic and logical operations; (ii) a microcontroller designed for specific tasks such as controlling electronic devices, sensors, and motors; (iii) a graphics processing unit (GPU) designed to accelerate the creation and rendering of images, videos, and animations (e.g., virtual-reality animations, such as three-dimensional modeling); (iv) a field-programmable gate array (FPGA) that can be programmed and reconfigured after manufacturing and/or customized to perform specific tasks, such as signal processing, cryptography, and machine learning; (v) a digital signal processor (DSP) designed to perform mathematical operations on signals such as audio, video, and radio waves. One of skill in the art will understand that one or more processors of one or more electronic devices may be used in various embodiments described herein.

As described herein, controllers are electronic components that manage and coordinate the operation of other components within an electronic device (e.g., controlling inputs, processing data, and/or generating outputs). Examples of controllers can include (i) microcontrollers, including small, low-power controllers that are commonly used in embedded systems and Internet of Things (IoT) devices; (ii) programmable logic controllers (PLCs) that may be configured to be used in industrial automation systems to control and monitor manufacturing processes; (iii) system-on-a-chip (SoC) controllers that integrate multiple components such as processors, memory, I/O interfaces, and other peripherals into a single chip; and/or DSPs. As described herein, a graphics module is a component or software module that is designed to handle graphical operations and/or processes, and can include a hardware module and/or a software module.

As described herein, memory refers to electronic components in a computer or electronic device that store data and instructions for the processor to access and manipulate. The devices described herein can include volatile and non-volatile memory. Examples of memory can include (i) random access memory (RAM), such as DRAM, SRAM, DDR RAM or other random access solid state memory devices, configured to store data and instructions temporarily; (ii) read-only memory (ROM) configured to store data and instructions permanently (e.g., one or more portions of system firmware and/or boot loaders); (iii) flash memory, magnetic disk storage devices, optical disk storage devices, other non-volatile solid state storage devices, which can be configured to store data in electronic devices (e.g., universal serial bus (USB) drives, memory cards, and/or solid-state drives (SSDs)); and (iv) cache memory configured to temporarily store frequently accessed data and instructions. Memory, as described herein, can include structured data (e.g., SQL databases, MongoDB databases, GraphQL data, or JSON data). Other examples of memory can include: (i) profile data, including user account data, user settings, and/or other user data stored by the user; (ii) sensor data detected and/or otherwise obtained by one or more sensors; (iii) media content data including stored image data, audio data, documents, and the like; (iv) application data, which can include data collected and/or otherwise obtained and stored during use of an application; and/or any other types of data described herein.

As described herein, a power system of an electronic device is configured to convert incoming electrical power into a form that can be used to operate the device. A power system can include various components, including (i) a power source, which can be an alternating current (AC) adapter or a direct current (DC) adapter power supply; (ii) a charger input that can be configured to use a wired and/or wireless connection (which may be part of a peripheral interface, such as a USB, micro-USB interface, near-field magnetic coupling, magnetic inductive and magnetic resonance charging, and/or radio frequency (RF) charging); (iii) a power-management integrated circuit, configured to distribute power to various components of the device and ensure that the device operates within safe limits (e.g., regulating voltage, controlling current flow, and/or managing heat dissipation); and/or (iv) a battery configured to store power to provide usable power to components of one or more electronic devices.

As described herein, peripheral interfaces are electronic components (e.g., of electronic devices) that allow electronic devices to communicate with other devices or peripherals and can provide a means for input and output of data and signals. Examples of peripheral interfaces can include (i) USB and/or micro-USB interfaces configured for connecting devices to an electronic device; (ii) Bluetooth interfaces configured to allow devices to communicate with each other, including Bluetooth low energy (BLE); (iii) near-field communication (NFC) interfaces configured to be short-range wireless interfaces for operations such as access control; (iv) POGO pins, which may be small, spring-loaded pins configured to provide a charging interface; (v) wireless charging interfaces; (vi) global-position system (GPS) interfaces; (vii) Wi-Fi interfaces for providing a connection between a device and a wireless network; and (viii) sensor interfaces.

As described herein, sensors are electronic components (e.g., in and/or otherwise in electronic communication with electronic devices, such as wearable devices) configured to detect physical and environmental changes and generate electrical signals. Examples of sensors can include (i) imaging sensors for collecting imaging data (e.g., including one or more cameras disposed on a respective electronic device); (ii) biopotential-signal sensors; (iii) inertial measurement unit (e.g., IMUs) for detecting, for example, angular rate, force, magnetic field, and/or changes in acceleration; (iv) heart rate sensors for measuring a user's heart rate; (v) SpO2 sensors for measuring blood oxygen saturation and/or other biometric data of a user; (vi) capacitive sensors for detecting changes in potential at a portion of a user's body (e.g., a sensor-skin interface) and/or the proximity of other devices or objects; and (vii) light sensors (e.g., ToF sensors, infrared light sensors, or visible light sensors), and/or sensors for sensing data from the user or the user's environment. As described herein biopotential-signal-sensing components are devices used to measure electrical activity within the body (e.g., biopotential-signal sensors). Some types of biopotential-signal sensors include: (i) electroencephalography (EEG) sensors configured to measure electrical activity in the brain to diagnose neurological disorders; (ii) electrocardiogram EKG) sensors configured to measure electrical activity of the heart to diagnose heart problems; (iii) electromyography (EMG) sensors configured to measure the electrical activity of muscles and diagnose neuromuscular disorders; (iv) electrooculography (EOG) sensors configured to measure the electrical activity of eye muscles to detect eye movement and diagnose eye disorders.

As described herein, an application stored in memory of an electronic device (e.g., software) includes instructions stored in the memory. Examples of such applications include (i) games; (ii) word processors; (iii) messaging applications; (iv) media-streaming applications; (v) financial applications; (vi) calendars; (vii) clocks; (viii) web browsers; (ix) social media applications, (x) camera applications, (xi) web-based applications; (xii) health applications; (xiii) artificial-reality (AR) applications, and/or any other applications that can be stored in memory. The applications can operate in conjunction with data and/or one or more components of a device or communicatively coupled devices to perform one or more operations and/or functions.

As described herein, communication interface modules can include hardware and/or software capable of data communications using any of a variety of custom or standard wireless protocols (e.g., IEEE 802.15.4, Wi-Fi, ZigBee, 6LoWPAN, Thread, Z-Wave, Bluetooth Smart, ISA100.11a, WirelessHART, or MiWi), custom or standard wired protocols (e.g., Ethernet or HomePlug), and/or any other suitable communication protocol, including communication protocols not yet developed as of the filing date of this document. A communication interface is a mechanism that enables different systems or devices to exchange information and data with each other, including hardware, software, or a combination of both hardware and software. For example, a communication interface can refer to a physical connector and/or port on a device that enables communication with other devices (e.g., USB, Ethernet, HDMI, or Bluetooth). In some embodiments, a communication interface can refer to a software layer that enables different software programs to communicate with each other (e.g., application programming interfaces (APIs) and protocols such as HTTP and TCP/IP).

As described herein, a graphics module is a component or software module that is designed to handle graphical operations and/or processes, and can include a hardware module and/or a software module.

As described herein, non-transitory computer-readable storage media are physical devices or storage medium that can be used to store electronic data in a non-transitory form (e.g., such that the data is stored permanently until it is intentionally deleted or modified).

### Example AR Systems

FIGS. 6A, 6B, 6C-1, 6C-2, 6D-1, and 6D-2 illustrate example AR systems, in accordance with some embodiments. FIG. 6A shows an AR system 600a and example user interactions using a wrist-wearable device 700, a head-wearable device (e.g., AR device 800), and/or a handheld intermediary processing device (HIPD) 900. FIG. 6B shows an AR system 600b and example user interactions using a wrist-wearable device 700, AR device 800, and/or an HIPD 900. FIGS. 6C-1 and 6C-2 show a third AR system 600c and third example user interactions using a wrist-wearable device 700, a head-wearable device (e.g., virtual-reality (VR) device 810), and/or an HIPD 900. FIGS. 6D-1 and 6D-2 show a fourth AR system 600d and fourth example user interactions using a wrist-wearable device 700, a VR device 810, and/or a smart textile-based garment 652 (e.g., wearable gloves, haptic gloves). As the skilled artisan will appreciate upon reading the descriptions provided herein, the above-example AR systems (described in detail below) can perform various functions and/or operations described above with reference to FIGS. 1-5.

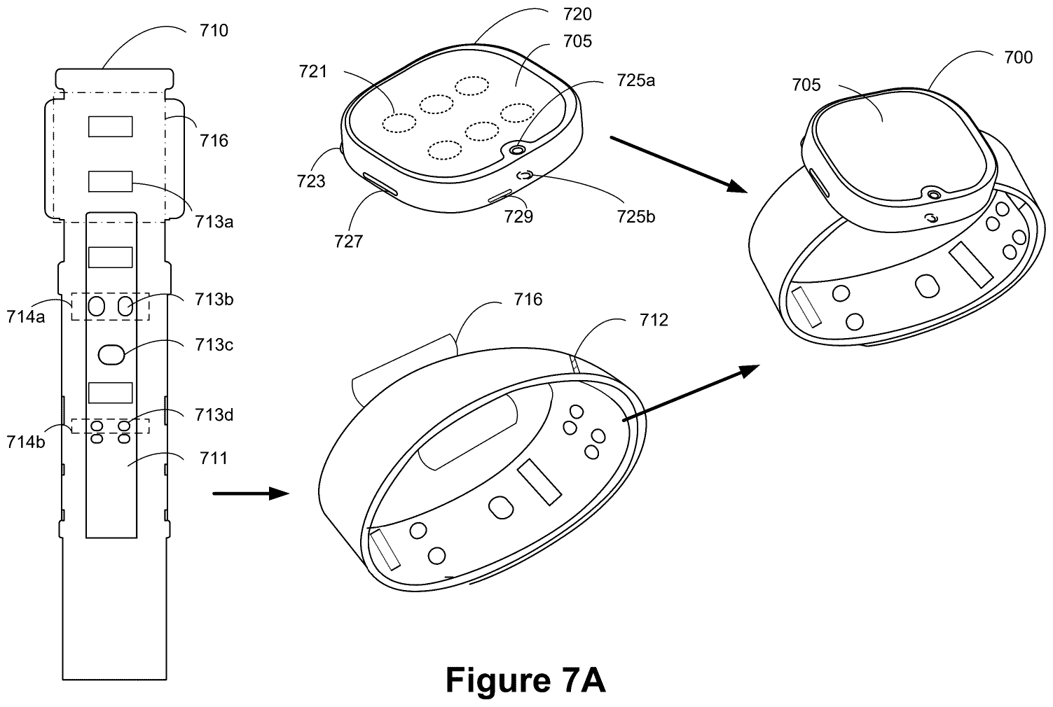

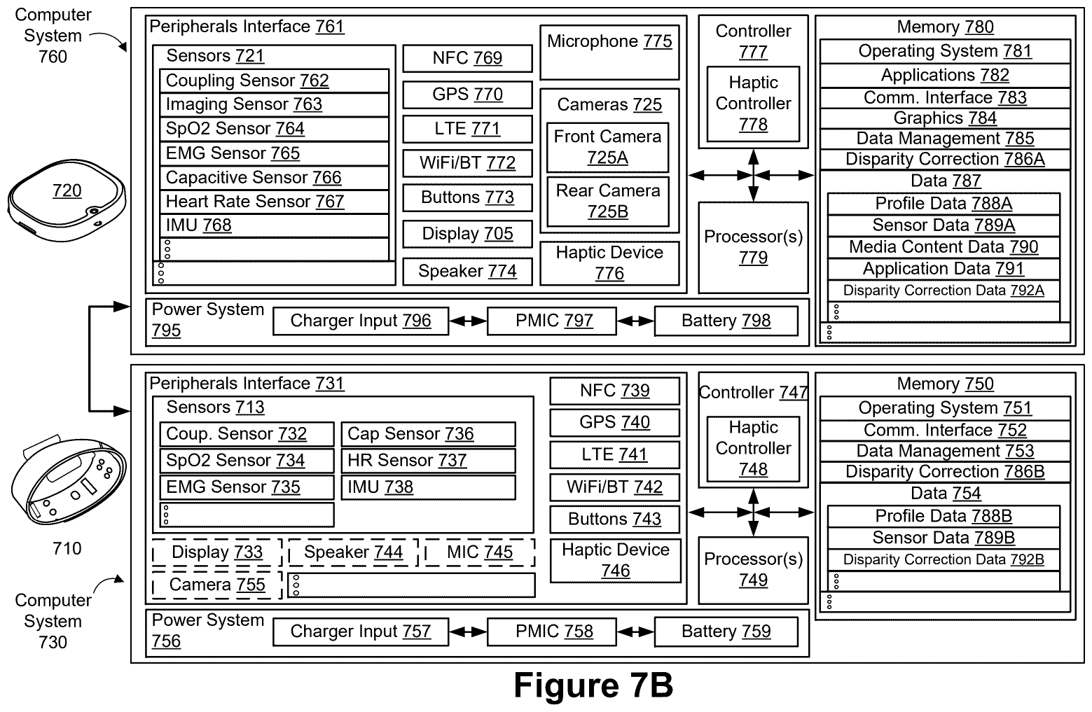

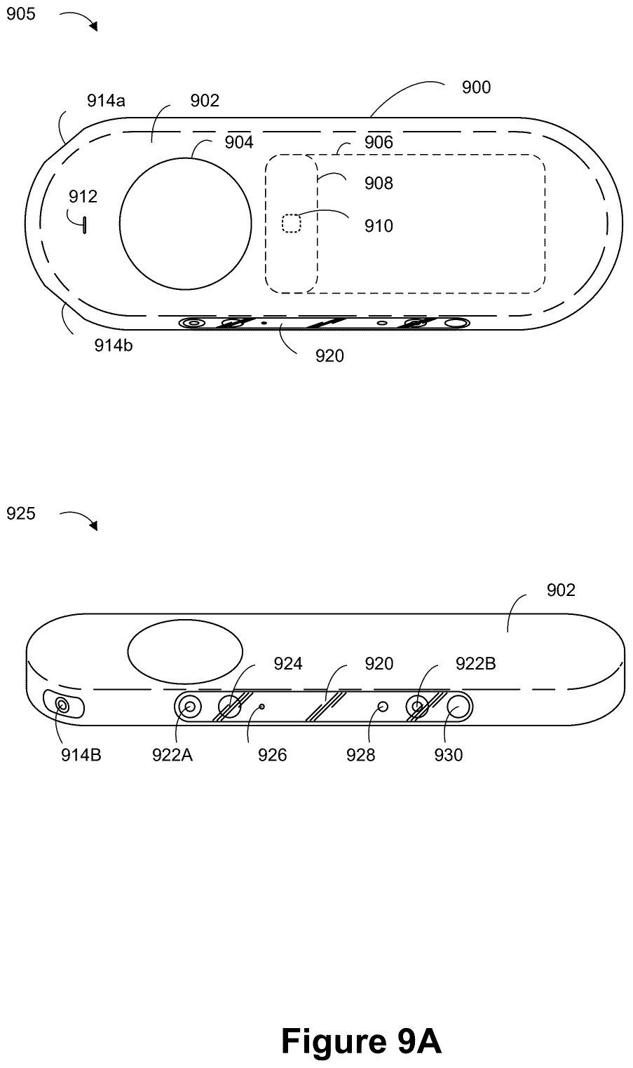

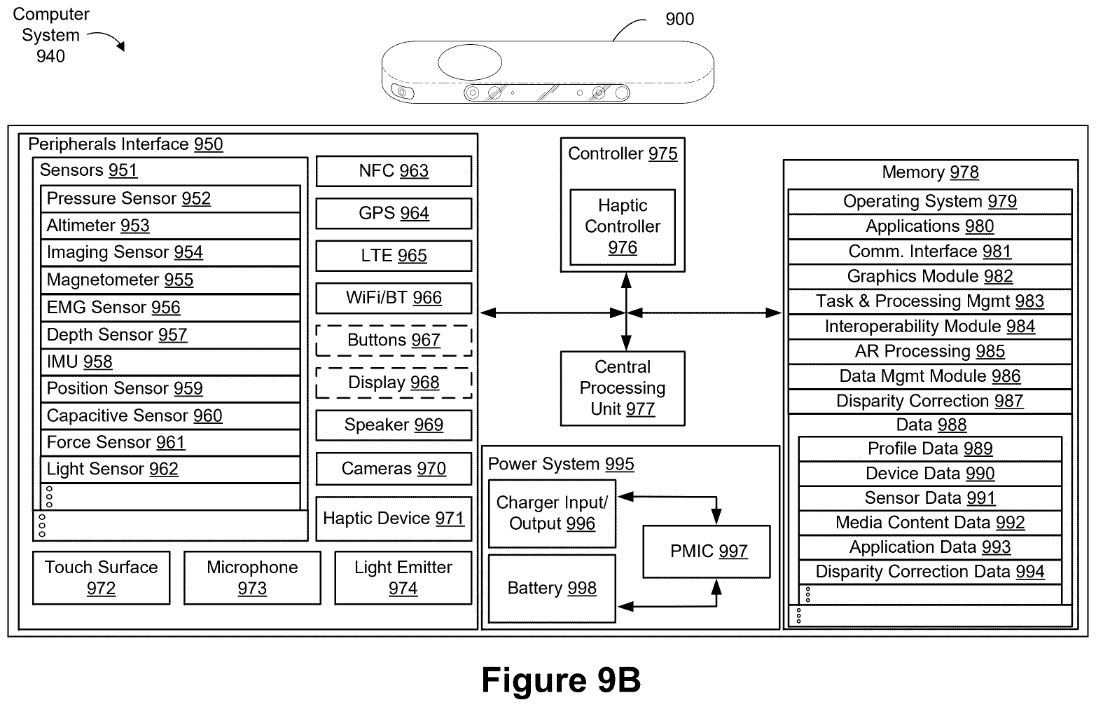

The wrist-wearable device 700 and its constituent components are described below in reference to FIGS. 7A-7B, the head-wearable devices and their constituent components are described below in reference to FIGS. 8A-8D, and the HIPD 900 and its constituent components are described below in reference to FIGS. 9A-9B. The wrist-wearable device 700, the head-wearable devices, and/or the HIPD 900 can communicatively couple via a network 625 (e.g., cellular, near field, Wi-Fi, personal area network, or wireless LAN). Additionally, the wrist-wearable device 700, the head-wearable devices, and/or the HIPD 900 can also communicatively couple with one or more servers 630, computers 640 (e.g., laptops or computers), mobile devices 650 (e.g., smartphones or tablets), and/or other electronic devices via the network 625 (e.g., cellular, near field, Wi-Fi, personal area network, or wireless LAN). Similarly, the smart textile-based garment 652, when used, can also communicatively couple with the wrist-wearable device 700, the head-wearable devices, the HIPD 900, the one or more servers 630, the computers 640, the mobile devices 650, and/or other electronic devices via the network 625.

Turning to FIG. 6A, a user 602 is shown wearing the wrist-wearable device 700 and the AR device 800, and having the HIPD 900 on their desk. The wrist-wearable device 700, the AR device 800, and the HIPD 900 facilitate user interaction with an AR environment. In particular, as shown by the AR system 600a, the wrist-wearable device 700, the AR device 800, and/or the HIPD 900 cause presentation of one or more avatars 604, digital representations of contacts 606, and virtual objects 608. As discussed below, the user 602 can interact with the one or more avatars 604, digital representations of the contacts 606, and virtual objects 608 via the wrist-wearable device 700, the AR device 800, and/or the HIPD 900.

The user 602 can use any of the wrist-wearable device 700, the AR device 800, and/or the HIPD 900 to provide user inputs. For example, the user 602 can perform one or more hand gestures that are detected by the wrist-wearable device 700 (e.g., using one or more EMG sensors and/or IMUs, described below in reference to FIGS. 7A-7B) and/or AR device 800 (e.g., using one or more image sensors, light sensors, or cameras, described below in reference to FIGS. 8A-8B) to provide a user input. Alternatively, or additionally, the user 602 can provide a user input via one or more touch surfaces of the wrist-wearable device 700, the AR device 800, and/or the HIPD 900, and/or voice commands captured by a microphone of the wrist-wearable device 700, the AR device 800, and/or the HIPD 900. In some embodiments, the wrist-wearable device 700, the AR device 800, and/or the HIPD 900 include a digital assistant to help the user in providing a user input (e.g., completing a sequence of operations, suggesting different operations or commands, providing reminders, or confirming a command). In some embodiments, the user 602 can provide a user input via one or more facial gestures and/or facial expressions. For example, cameras of the wrist-wearable device 700, the AR device 800, and/or the HIPD 900 can track the user 602's eyes for navigating a user interface.

The wrist-wearable device 700, the AR device 800, and/or the HIPD 900 can operate alone or in conjunction to allow the user 602 to interact with the AR environment. In some embodiments, the HIPD 900 is configured to operate as a central hub or control center for the wrist-wearable device 700, the AR device 800, and/or another communicatively coupled device. For example, the user 602 can provide an input to interact with the AR environment at any of the wrist-wearable device 700, the AR device 800, and/or the HIPD 900, and the HIPD 900 can identify one or more back-end and front-end tasks to cause the performance of the requested interaction and distribute instructions to cause the performance of the one or more back-end and front-end tasks at the wrist-wearable device 700, the AR device 800, and/or the HIPD 900. In some embodiments, a back-end task is a background-processing task that is not perceptible by the user (e.g., rendering content, decompression, or compression), and a front-end task is a user-facing task that is perceptible to the user (e.g., presenting information to the user or providing feedback to the user). As described below in reference to FIGS. 9A-9B, the HIPD 900 can perform the back-end tasks and provide the wrist-wearable device 700 and/or the AR device 800 operational data corresponding to the performed back-end tasks such that the wrist-wearable device 700 and/or the AR device 800 can perform the front-end tasks. In this way, the HIPD 900, which has more computational resources and greater thermal headroom than the wrist-wearable device 700 and/or the AR device 800, performs computationally intensive tasks and reduces the computer resource utilization and/or power usage of the wrist-wearable device 700 and/or the AR device 800.

In the example shown by the AR system 600a, the HIPD 900 identifies one or more back-end tasks and front-end tasks associated with a user request to initiate an AR video call with one or more other users (represented by the avatar 604 and the digital representation of the contact 606) and distributes instructions to cause the performance of the one or more back-end tasks and front-end tasks. In particular, the HIPD 900 performs back-end tasks for processing and/or rendering image data (and other data) associated with the AR video call and provides operational data associated with the performed back-end tasks to the AR device 800 such that the AR device 800 performs front-end tasks for presenting the AR video call (e.g., presenting the avatar 604 and the digital representation of the contact 606).

In some embodiments, the HIPD 900 can operate as a focal or anchor point for causing the presentation of information. This allows the user 602 to be generally aware of where information is presented. For example, as shown in the AR system 600a, the avatar 604 and the digital representation of the contact 606 are presented above the HIPD 900. In particular, the HIPD 900 and the AR device 800 operate in conjunction to determine a location for presenting the avatar 604 and the digital representation of the contact 606. In some embodiments, information can be presented within a predetermined distance from the HIPD 900 (e.g., within five meters). For example, as shown in the AR system 600a, virtual object 608 is presented on the desk some distance from the HIPD 900. Similar to the above example, the HIPD 900 and the AR device 800 can operate in conjunction to determine a location for presenting the virtual object 608. Alternatively, in some embodiments, presentation of information is not bound by the HIPD 900. More specifically, the avatar 604, the digital representation of the contact 606, and the virtual object 608 do not have to be presented within a predetermined distance of the HIPD 900.

User inputs provided at the wrist-wearable device 700, the AR device 800, and/or the HIPD 900 are coordinated such that the user can use any device to initiate, continue, and/or complete an operation. For example, the user 602 can provide a user input to the AR device 800 to cause the AR device 800 to present the virtual object 608 and, while the virtual object 608 is presented by the AR device 800, the user 602 can provide one or more hand gestures via the wrist-wearable device 700 to interact and/or manipulate the virtual object 608.

FIG. 6B shows the user 602 wearing the wrist-wearable device 700 and the AR device 800, and holding the HIPD 900. In the AR system 600b, the wrist-wearable device 700, the AR device 800, and/or the HIPD 900 are used to receive and/or provide one or more messages to a contact of the user 602. In particular, the wrist-wearable device 700, the AR device 800, and/or the HIPD 900 detect and coordinate one or more user inputs to initiate a messaging application and prepare a response to a received message via the messaging application.

In some embodiments, the user 602 initiates, via a user input, an application on the wrist-wearable device 700, the AR device 800, and/or the HIPD 900 that causes the application to initiate on at least one device. For example, in the AR system 600b, the user 602 performs a hand gesture associated with a command for initiating a messaging application (represented by messaging user interface 612), the wrist-wearable device 700 detects the hand gesture, and, based on a determination that the user 602 is wearing AR device 800, causes the AR device 800 to present a messaging user interface 612 of the messaging application. The AR device 800 can present the messaging user interface 612 to the user 602 via its display (e.g., as shown by user 602's field of view 610). In some embodiments, the application is initiated and can be run on the device (e.g., the wrist-wearable device 700, the AR device 800, and/or the HIPD 900) that detects the user input to initiate the application, and the device provides another device operational data to cause the presentation of the messaging application. For example, the wrist-wearable device 700 can detect the user input to initiate a messaging application, initiate and run the messaging application, and provide operational data to the AR device 800 and/or the HIPD 900 to cause presentation of the messaging application. Alternatively, the application can be initiated and run at a device other than the device that detected the user input. For example, the wrist-wearable device 700 can detect the hand gesture associated with initiating the messaging application and cause the HIPD 900 to run the messaging application and coordinate the presentation of the messaging application.

Further, the user 602 can provide a user input provided at the wrist-wearable device 700, the AR device 800, and/or the HIPD 900 to continue and/or complete an operation initiated at another device. For example, after initiating the messaging application via the wrist-wearable device 700 and while the AR device 800 presents the messaging user interface 612, the user 602 can provide an input at the HIPD 900 to prepare a response (e.g., shown by the swipe gesture performed on the HIPD 900). The user 602's gestures performed on the HIPD 900 can be provided and/or displayed on another device. For example, the user 602's swipe gestures performed on the HIPD 900 are displayed on a virtual keyboard of the messaging user interface 612 displayed by the AR device 800.

In some embodiments, the wrist-wearable device 700, the AR device 800, the HIPD 900, and/or other communicatively coupled devices can present one or more notifications to the user 602. The notification can be an indication of a new message, an incoming call, an application update, a status update, etc. The user 602 can select the notification via the wrist-wearable device 700, the AR device 800, or the HIPD 900 and cause presentation of an application or operation associated with the notification on at least one device. For example, the user 602 can receive a notification that a message was received at the wrist-wearable device 700, the AR device 800, the HIPD 900, and/or other communicatively coupled device and provide a user input at the wrist-wearable device 700, the AR device 800, and/or the HIPD 900 to review the notification, and the device detecting the user input can cause an application associated with the notification to be initiated and/or presented at the wrist-wearable device 700, the AR device 800, and/or the HIPD 900.

While the above example describes coordinated inputs used to interact with a messaging application, the skilled artisan will appreciate upon reading the descriptions that user inputs can be coordinated to interact with any number of applications including, but not limited to, gaming applications, social media applications, camera applications, web-based applications, financial applications, etc. For example, the AR device 800 can present to the user 602 game application data and the HIPD 900 can use a controller to provide inputs to the game. Similarly, the user 602 can use the wrist-wearable device 700 to initiate a camera of the AR device 800, and the user can use the wrist-wearable device 700, the AR device 800, and/or the HIPD 900 to manipulate the image capture (e.g., zoom in or out or apply filters) and capture image data.

Turning to FIGS. 6C-1 and 6C-2, the user 602 is shown wearing the wrist-wearable device 700 and a VR device 810, and holding the HIPD 900. In the third AR system 600c, the wrist-wearable device 700, the VR device 810, and/or the HIPD 900 are used to interact within an AR environment, such as a VR game or other AR application. While the VR device 810 presents a representation of a VR game (e.g., AR game environment 620) to the user 602, the wrist-wearable device 700, the VR device 810, and/or the HIPD 900 detect and coordinate one or more user inputs to allow the user 602 to interact with the VR game.

In some embodiments, the user 602 can provide a user input via the wrist-wearable device 700, the VR device 810, and/or the HIPD 900 that causes an action in a corresponding AR environment. For example, the user 602 in the third AR system 600c (shown in FIG. 6C-1) raises the HIPD 900 to prepare for a swing in the AR game environment 620. The VR device 810, responsive to the user 602 raising the HIPD 900, causes the AR representation of the user 622 to perform a similar action (e.g., raise a virtual object, such as a virtual sword 624). In some embodiments, each device uses respective sensor data and/or image data to detect the user input and provide an accurate representation of the user 602's motion. For example, imaging sensors 954 (e.g., SLAM cameras or other cameras discussed below in FIGS. 9A and 9B) of the HIPD 900 can be used to detect a position of the 900 relative to the user 602's body such that the virtual object can be positioned appropriately within the AR game environment 620; sensor data from the wrist-wearable device 700 can be used to detect a velocity at which the user 602 raises the HIPD 900 such that the AR representation of the user 622 and the virtual sword 624 are synchronized with the user 602's movements; and light sensors 868 (FIGS. 8A-8C) of the VR device 810 can be used to represent the user 602's body, boundary conditions, or real-world objects within the AR game environment 620.

In FIG. 6C-2, the user 602 performs a downward swing while holding the HIPD 900. The user 602's downward swing is detected by the wrist-wearable device 700, the VR device 810, and/or the HIPD 900 and a corresponding action is performed in the AR game environment 620. In some embodiments, the data captured by each device is used to improve the user's experience within the AR environment. For example, sensor data of the wrist-wearable device 700 can be used to determine a speed and/or force at which the downward swing is performed and image sensors of the HIPD 900 and/or the VR device 810 can be used to determine a location of the swing and how it should be represented in the AR game environment 620, which, in turn, can be used as inputs for the AR environment (e.g., game mechanics, which can use detected speed, force, locations, and/or aspects of the user 602's actions to classify a user's inputs (e.g., user performs a light strike, hard strike, critical strike, glancing strike, miss) or calculate an output (e.g., amount of damage)).

While the wrist-wearable device 700, the VR device 810, and/or the HIPD 900 are described as detecting user inputs, in some embodiments, user inputs are detected at a single device (with the single device being responsible for distributing signals to the other devices for performing the user input). For example, the HIPD 900 can operate an application for generating the AR game environment 620 and provide the VR device 810 with corresponding data for causing the presentation of the AR game environment 620, as well as detect the 602's movements (while holding the HIPD 900) to cause the performance of corresponding actions within the AR game environment 620. Additionally or alternatively, in some embodiments, operational data (e.g., sensor data, image data, application data, device data, and/or other data) of one or more devices is provide to a single device (e.g., the HIPD 900) to process the operational data and cause respective devices to perform an action associated with processed operational data.

In FIGS. 6D-1 and 6D-2, the user 602 is shown wearing the wrist-wearable device 700, the VR device 810, and smart textile-based garments 652. In the fourth AR system 600d, the wrist-wearable device 700, the VR device 810, and/or the smart textile-based garments 652 are used to interact within an AR environment (e.g., any AR system described above in reference to FIGS. 6A-6C-2. While the VR device 810 presents a representation of a VR game (e.g., AR game environment 635) to the user 602, the wrist-wearable device 700, the VR device 810, and/or the smart textile-based garments 652 detect and coordinate one or more user inputs to allow the user 602 to interact with the AR environment.

In some embodiments, the user 602 can provide a user input via the wrist-wearable device 700, the VR device 810, and/or the smart textile-based garments 652 that causes an action in a corresponding AR environment. For example, the user 602 in the fourth AR system 600d (shown in FIG. 6D-1) raises a hand wearing the smart textile-based garments 652 to prepare to cast a spell or throw an object within the AR game environment 635. The VR device 810, responsive to the user 602 holding up their hand (wearing smart textile-based garments 652), causes the AR representation of the user 622 to perform a similar action (e.g., hold a virtual object or throw a fireball 634). In some embodiments, each device uses respective sensor data and/or image data to detect the user input and provides an accurate representation of the user 602's motion.

In FIG. 6D-2, the user 602 performs a throwing motion while wearing the smart textile-based garment 652. The user 602's throwing motion is detected by the wrist-wearable device 700, the VR device 810, and/or the smart textile-based garments 652, and a corresponding action is performed in the AR game environment 635. As described above, the data captured by each device is used to improve the user's experience within the AR environment. Although not shown, the smart textile-based garments 652 can be used in conjunction with an VR device 810 and/or an HIPD 900.

Having discussed example AR systems, devices for interacting with such AR systems, and other computing systems more generally, devices and components will now be discussed in greater detail below. Some definitions of devices and components that can be included in some or all of the example devices discussed below are defined here for ease of reference. A skilled artisan will appreciate that certain types of the components described below may be more suitable for a particular set of devices and less suitable for a different set of devices. But subsequent references to the components defined here should be considered to be encompassed by the definitions provided.

In some embodiments discussed below, example devices and systems, including electronic devices and systems, will be discussed. Such example devices and systems are not intended to be limiting, and one of skill in the art will understand that alternative devices and systems to the example devices and systems described herein may be used to perform the operations and construct the systems and devices that are described herein.

As described herein, an electronic device is a device that uses electrical energy to perform a specific function. It can be any physical object that contains electronic components such as transistors, resistors, capacitors, diodes, and integrated circuits. Examples of electronic devices include smartphones, laptops, digital cameras, televisions, gaming consoles, and music players, as well as the example electronic devices discussed herein. As described herein, an intermediary electronic device is a device that sits between two other electronic devices and/or a subset of components of one or more electronic devices, which facilitates communication, and/or data processing, and/or data transfer between the respective electronic devices and/or electronic components.

### Example Wrist-Wearable Devices

FIGS. 7A and 7B illustrate an example wrist-wearable device 700, in accordance with some embodiments. FIG. 7A illustrates components of the wrist-wearable device 700, which can be used individually or in combination, including combinations that include other electronic devices and/or electronic components.

FIG. 7A shows a wearable band 710 and a watch body 720 (or capsule) being coupled, as discussed below, to form the wrist-wearable device 700. The wrist-wearable device 700 can perform various functions and/or operations associated with navigating through user interfaces and selectively opening applications, as well as the functions and/or operations described above with reference to FIGS. 1-5.

As will be described in more detail below, operations executed by the wrist-wearable device 700 can include (i) presenting content to a user (e.g., displaying visual content via a display 705); (ii) detecting (e.g., sensing) user input (e.g., sensing a touch on peripheral button 723 and/or at a touch screen of the display 705, a hand gesture detected by sensors (e.g., biopotential sensors)); (iii) sensing biometric data via one or more sensors 713 (e.g., neuromuscular signals, heart rate, temperature, or sleep); messaging (e.g., text, speech, or video); image capture via one or more imaging devices or cameras 725; wireless communications (e.g., cellular, near field, Wi-Fi, or personal area network); location determination; financial transactions; providing haptic feedback; alarms; notifications; biometric authentication; health monitoring; and/or sleep monitoring.

The above-example functions can be executed independently in the watch body 720, independently in the wearable band 710, and/or via an electronic communication between the watch body 720 and the wearable band 710. In some embodiments, functions can be executed on the wrist-wearable device 700 while an AR environment is being presented (e.g., via one of the AR systems 600a to 600d). As the skilled artisan will appreciate upon reading the descriptions provided herein, the novel wearable devices described herein can be used with other types of AR environments.

The wearable band 710 can be configured to be worn by a user such that an inner (or inside) surface of the wearable structure 711 of the wearable band 710 is in contact with the user's skin. When worn by a user, sensors 713 contact the user's skin. The sensors 713 can sense biometric data such as a user's heart rate, saturated oxygen level, temperature, sweat level, neuromuscular-signal sensors, or a combination thereof. The sensors 713 can also sense data about a user's environment, including a user's motion, altitude, location, orientation, gait, acceleration, position, or a combination thereof. In some embodiments, the sensors 713 are configured to track a position and/or motion of the wearable band 710. The one or more sensors 713 can include any of the sensors defined above and/or discussed below with respect to FIG. 7B.

The one or more sensors 713 can be distributed on an inside and/or an outside surface of the wearable band 710. In some embodiments, the one or more sensors 713 are uniformly spaced along the wearable band 710. Alternatively, in some embodiments, the one or more sensors 713 are positioned at distinct points along the wearable band 710. As shown in FIG. 7A, the one or more sensors 713 can be the same or distinct. For example, in some embodiments, the one or more sensors 713 can be shaped as a pill (e.g., sensor 713a), an oval, a circle a square, an oblong (e.g., sensor 713c), and/or any other shape that maintains contact with the user's skin (e.g., such that neuromuscular signal and/or other biometric data can be accurately measured at the user's skin). In some embodiments, the one or more sensors 713 are aligned to form pairs of sensors (e.g., for sensing neuromuscular signals based on differential sensing within each respective sensor). For example, sensor 713b is aligned with an adjacent sensor to form sensor pair 714a, and sensor 713d is aligned with an adjacent sensor to form sensor pair 714b. In some embodiments, the wearable band 710 does not have a sensor pair. Alternatively, in some embodiments, the wearable band 710 has a predetermined number of sensor pairs (one pair of sensors, three pairs of sensors, four pairs of sensors, six pairs of sensors, or sixteen pairs of sensors).

The wearable band 710 can include any suitable number of sensors 713. In some embodiments, the amount and arrangements of sensors 713 depend on the particular application for which the wearable band 710 is used. For instance, a wearable band 710 configured as an armband, wristband, or chest-band may include a plurality of sensors 713 with a different number of sensors 713 and different arrangement for each use case, such as medical use cases, compared to gaming or general day-to-day use cases.

In accordance with some embodiments, the wearable band 710 further includes an electrical ground electrode and a shielding electrode. The electrical ground and shielding electrodes, like the sensors 713, can be distributed on the inside surface of the wearable band 710 such that they contact a portion of the user's skin. For example, the electrical ground and shielding electrodes can be at an inside surface of coupling mechanism 716 or an inside surface of a wearable structure 711. The electrical ground and shielding electrodes can be formed and/or use the same components as the sensors 713. In some embodiments, the wearable band 710 includes more than one electrical ground electrode and more than one shielding electrode.

The sensors 713 can be formed as part of the wearable structure 711 of the wearable band 710. In some embodiments, the sensors 713 are flush or substantially flush with the wearable structure 711 such that they do not extend beyond the surface of the wearable structure 711. While flush with the wearable structure 711, the sensors 713 are still configured to contact the user's skin (e.g., via a skin-contacting surface). Alternatively, in some embodiments, the sensors 713 extend beyond the wearable structure 711 a predetermined distance (e.g., 0.1 mm to 2 mm) to make contact and depress into the user's skin. In some embodiments, the sensors 713 are coupled to an actuator (not shown) configured to adjust an extension height (e.g., a distance from the surface of the wearable structure 711) of the sensors 713 such that the sensors 713 make contact and depress into the user's skin. In some embodiments, the actuators adjust the extension height between 0.01 mm to 1.2 mm. This allows the user to customize the positioning of the sensors 713 to improve the overall comfort of the wearable band 710 when worn while still allowing the sensors 713 to contact the user's skin. In some embodiments, the sensors 713 are indistinguishable from the wearable structure 711 when worn by the user.

The wearable structure 711 can be formed of an elastic material, elastomers, etc., configured to be stretched and fitted to be worn by the user. In some embodiments, the wearable structure 711 is a textile or woven fabric. As described above, the sensors 713 can be formed as part of a wearable structure 711. For example, the sensors 713 can be molded into the wearable structure 711 or be integrated into a woven fabric (e.g., the sensors 713 can be sewn into the fabric and mimic the pliability of fabric (e.g., the sensors 713 can be constructed from a series of woven strands of fabric)).

The wearable structure 711 can include flexible electronic connectors that interconnect the sensors 713, the electronic circuitry, and/or other electronic components (described below in reference to FIG. 7B) that are enclosed in the wearable band 710. In some embodiments, the flexible electronic connectors are configured to interconnect the sensors 713, the electronic circuitry, and/or other electronic components of the wearable band 710 with respective sensors and/or other electronic components of another electronic device (e.g., watch body 720). The flexible electronic connectors are configured to move with the wearable structure 711 such that the user adjustment to the wearable structure 711 (e.g., resizing, pulling, or folding) does not stress or strain the electrical coupling of components of the wearable band 710.

As described above, the wearable band 710 is configured to be worn by a user. In particular, the wearable band 710 can be shaped or otherwise manipulated to be worn by a user. For example, the wearable band 710 can be shaped to have a substantially circular shape such that it can be configured to be worn on the user's lower arm or wrist. Alternatively, the wearable band 710 can be shaped to be worn on another body part of the user, such as the user's upper arm (e.g., around a bicep), forearm, chest, legs, etc. The wearable band 710 can include a retaining mechanism 712 (e.g., a buckle or a hook and loop fastener) for securing the wearable band 710 to the user's wrist or other body part. While the wearable band 710 is worn by the user, the sensors 713 sense data (referred to as sensor data) from the user's skin. In particular, the sensors 713 of the wearable band 710 obtain (e.g., sense and record) neuromuscular signals.

The sensed data (e.g., sensed neuromuscular signals) can be used to detect and/or determine the user's intention to perform certain motor actions. In particular, the sensors 713 sense and record neuromuscular signals from the user as the user performs muscular activations (e.g., movements or gestures). The detected and/or determined motor action (e.g., phalange (or digits) movements, wrist movements, hand movements, and/or other muscle intentions) can be used to determine control commands or control information (instructions to perform certain commands after the data is sensed) for causing a computing device to perform one or more input commands. For example, the sensed neuromuscular signals can be used to control certain user interfaces displayed on the display 705 of the wrist-wearable device 700 and/or can be transmitted to a device responsible for rendering an AR environment (e.g., a head-mounted display) to perform an action in an associated AR environment, such as to control the motion of a virtual device displayed to the user. The muscular activations performed by the user can include static gestures, such as placing the user's hand palm down on a table; dynamic gestures, such as grasping a physical or virtual object; and covert gestures that are imperceptible to another person, such as slightly tensing a joint by co-contracting opposing muscles or using sub-muscular activations. The muscular activations performed by the user can include symbolic gestures (e.g., gestures mapped to other gestures, interactions, or commands, for example, based on a gesture vocabulary that specifies the mapping of gestures to commands).

The sensor data sensed by the sensors 713 can be used to provide a user with an enhanced interaction with a physical object (e.g., devices communicatively coupled with the wearable band 710) and/or a virtual object in an AR application generated by an AR system (e.g., user interface objects presented on the display 705 or another computing device (e.g., a smartphone)).

In some embodiments, the wearable band 710 includes one or more haptic devices 746 (FIG. 7B; e.g., a vibratory haptic actuator) that are configured to provide haptic feedback (e.g., a cutaneous and/or kinesthetic sensation) to the user's skin. The sensors 713 and/or the haptic devices 746 can be configured to operate in conjunction with multiple applications including, without limitation, health monitoring, social media, games, and AR (e.g., the applications associated with AR).

The wearable band 710 can also include a coupling mechanism 716 (e.g., a cradle or a shape of the coupling mechanism can correspond to the shape of the watch body 720 of the wrist-wearable device 700) for detachably coupling a capsule (e.g., a computing unit) or watch body 720 (via a coupling surface of the watch body 720) to the wearable band 710. In particular, the coupling mechanism 716 can be configured to receive a coupling surface proximate to the bottom side of the watch body 720 (e.g., a side opposite to a front side of the watch body 720 where the display 705 is located), such that a user can push the watch body 720 downward into the coupling mechanism 716 to attach the watch body 720 to the coupling mechanism 716. In some embodiments, the coupling mechanism 716 can be configured to receive a top side of the watch body 720 (e.g., a side proximate to the front side of the watch body 720 where the display 705 is located) that is pushed upward into the cradle, as opposed to being pushed downward into the coupling mechanism 716. In some embodiments, the coupling mechanism 716 is an integrated component of the wearable band 710 such that the wearable band 710 and the coupling mechanism 716 are a single unitary structure. In some embodiments, the coupling mechanism 716 is a type of frame or shell that allows the watch body 720 coupling surface to be retained within or on the wearable band 710 coupling mechanism 716 (e.g., a cradle, a tracker band, a support base, or a clasp).

The coupling mechanism 716 can allow for the watch body 720 to be detachably coupled to the wearable band 710 through a friction fit, a magnetic coupling, a rotation-based connector, a shear-pin coupler, a retention spring, one or more magnets, a clip, a pin shaft, a hook-and-loop fastener, or a combination thereof. A user can perform any type of motion to couple the watch body 720 to the wearable band 710 and to decouple the watch body 720 from the wearable band 710. For example, a user can twist, slide, turn, push, pull, or rotate the watch body 720 relative to the wearable band 710, or a combination thereof, to attach the watch body 720 to the wearable band 710 and to detach the watch body 720 from the wearable band 710. Alternatively, as discussed below, in some embodiments, the watch body 720 can be decoupled from the wearable band 710 by actuation of the release mechanism 729.

The wearable band 710 can be coupled with a watch body 720 to increase the functionality of the wearable band 710 (e.g., converting the wearable band 710 into a wrist-wearable device 700, adding an additional computing unit and/or battery to increase computational resources and/or a battery life of the wearable band 710, or adding additional sensors to improve sensed data). As described above, the wearable band 710 (and the coupling mechanism 716) is configured to operate independently (e.g., execute functions independently) from watch body 720. For example, the coupling mechanism 716 can include one or more sensors 713 that contact a user's skin when the wearable band 710 is worn by the user and provide sensor data for determining control commands.

A user can detach the watch body 720 (or capsule) from the wearable band 710 in order to reduce the encumbrance of the wrist-wearable device 700 to the user. For embodiments in which the watch body 720 is removable, the watch body 720 can be referred to as a removable structure, such that in these embodiments the wrist-wearable device 700 includes a wearable portion (e.g., the wearable band 710) and a removable structure (the watch body 720).

Turning to the watch body 720, the watch body 720 can have a substantially rectangular or circular shape. The watch body 720 is configured to be worn by the user on their wrist or on another body part. More specifically, the watch body 720 is sized to be easily carried by the user, attached on a portion of the user's clothing, and/or coupled to the wearable band 710 (forming the wrist-wearable device 700). As described above, the watch body 720 can have a shape corresponding to the coupling mechanism 716 of the wearable band 710. In some embodiments, the watch body 720 includes a single release mechanism 729 or multiple release mechanisms (e.g., two release mechanisms 729 positioned on opposing sides of the watch body 720, such as spring-loaded buttons) for decoupling the watch body 720 and the wearable band 710. The release mechanism 729 can include, without limitation, a button, a knob, a plunger, a handle, a lever, a fastener, a clasp, a dial, a latch, or a combination thereof.

A user can actuate the release mechanism 729 by pushing, turning, lifting, depressing, shifting, or performing other actions on the release mechanism 729. Actuation of the release mechanism 729 can release (e.g., decouple) the watch body 720 from the coupling mechanism 716 of the wearable band 710, allowing the user to use the watch body 720 independently from wearable band 710 and vice versa. For example, decoupling the watch body 720 from the wearable band 710 can allow the user to capture images using rear-facing camera 725b. Although the coupling mechanism 716 is shown positioned at a corner of watch body 720, the release mechanism 729 can be positioned anywhere on watch body 720 that is convenient for the user to actuate. In addition, in some embodiments, the wearable band 710 can also include a respective release mechanism for decoupling the watch body 720 from the coupling mechanism 716. In some embodiments, the release mechanism 729 is optional and the watch body 720 can be decoupled from the coupling mechanism 716, as described above (e.g., via twisting or rotating).

The watch body 720 can include one or more peripheral buttons 723 and 727 for performing various operations at the watch body 720. For example, the peripheral buttons 723 and 727 can be used to turn on or wake (e.g., transition from a sleep state to an active state) the display 705, unlock the watch body 720, increase or decrease volume, increase or decrease brightness, interact with one or more applications, interact with one or more user interfaces. Additionally, or alternatively, in some embodiments, the display 705 operates as a touch screen and allows the user to provide one or more inputs for interacting with the watch body 720.

In some embodiments, the watch body 720 includes one or more sensors 721. The sensors 721 of the watch body 720 can be the same or distinct from the sensors 713 of the wearable band 710. The sensors 721 of the watch body 720 can be distributed on an inside and/or an outside surface of the watch body 720. In some embodiments, the sensors 721 are configured to contact a user's skin when the watch body 720 is worn by the user. For example, the sensors 721 can be placed on the bottom side of the watch body 720 and the coupling mechanism 716 can be a cradle with an opening that allows the bottom side of the watch body 720 to directly contact the user's skin. Alternatively, in some embodiments, the watch body 720 does not include sensors that are configured to contact the user's skin (e.g., including sensors internal and/or external to the watch body 720 that are configured to sense data of the watch body 720 and the watch body 720's surrounding environment). In some embodiments, the sensors 713 are configured to track a position and/or motion of the watch body 720.

The watch body 720 and the wearable band 710 can share data using a wired communication method (e.g., a Universal Asynchronous Receiver/Transmitter (UART) or a USB transceiver) and/or a wireless communication method (e.g., near-field communication or Bluetooth). For example, the watch body 720 and the wearable band 710 can share data sensed by the sensors 713 and 721, as well as application- and device-specific information (e.g., active and/or available applications), output devices (e.g., display or speakers), and/or input devices (e.g., touch screens, microphones, or imaging sensors).

In some embodiments, the watch body 720 can include, without limitation, a front-facing camera 725a and/or a rear-facing camera 725b, sensors 721 (e.g., a biometric sensor, an IMU sensor, a heart rate sensor, a saturated oxygen sensor, a neuromuscular-signal sensor, an altimeter sensor, a temperature sensor, a bioimpedance sensor, a pedometer sensor, an optical sensor (e.g., FIG. 7B; imaging sensor 763), a touch sensor, a sweat sensor). In some embodiments, the watch body 720 can include one or more haptic devices 776 (FIG. 7B; a vibratory haptic actuator) that is configured to provide haptic feedback (e.g., a cutaneous and/or kinesthetic sensation) to the user. The sensors 721 and/or the haptic device 776 can also be configured to operate in conjunction with multiple applications, including, without limitation, health-monitoring applications, social media applications, game applications, and AR applications (e.g., the applications associated with AR).

As described above, the watch body 720 and the wearable band 710, when coupled, can form the wrist-wearable device 700. When coupled, the watch body 720 and wearable band 710 operate as a single device to execute functions (e.g., operations, detections, or communications) described herein. In some embodiments, each device is provided with particular instructions for performing the one or more operations of the wrist-wearable device 700. For example, in accordance with a determination that the watch body 720 does not include neuromuscular-signal sensors, the wearable band 710 can include alternative instructions for performing associated instructions (e.g., providing sensed neuromuscular-signal data to the watch body 720 via a different electronic device). Operations of the wrist-wearable device 700 can be performed by the watch body 720 alone or in conjunction with the wearable band 710 (e.g., via respective processors and/or hardware components) and vice versa. In some embodiments, operations of the wrist-wearable device 700, the watch body 720, and/or the wearable band 710 can be performed in conjunction with one or more processors and/or hardware components of another communicatively coupled device (e.g., FIGS. 9A-9B; the HIPD 900).

As described below with reference to the block diagram of FIG. 7B, the wearable band 710 and/or the watch body 720 can each include independent resources required to independently execute functions. For example, the wearable band 710 and/or the watch body 720 can each include a power source (e.g., a battery), a memory, data storage, a processor (e.g., a CPU), communications, a light source, and/or input/output devices.

FIG. 7B shows block diagrams of a wearable band computing system 730 corresponding to the wearable band 710 and a watch body computing system 760 corresponding to the watch body 720, according to some embodiments. A computing system of the wrist-wearable device 700 includes a combination of components of the wearable band computing system 730 and the watch body computing system 760, in accordance with some embodiments.

The watch body 720 and/or the wearable band 710 can include one or more components shown in watch body computing system 760. In some embodiments, a single integrated circuit includes all or a substantial portion of the components of the watch body computing system 760 that are included in a single integrated circuit. Alternatively, in some embodiments, components of the watch body computing system 760 are included in a plurality of integrated circuits that are communicatively coupled. In some embodiments, the watch body computing system 760 is configured to couple (e.g., via a wired or wireless connection) with the wearable band computing system 730, which allows the computing systems to share components, distribute tasks, and/or perform other operations described herein (individually or as a single device).

The watch body computing system 760 can include one or more processors 779, a controller 777, a peripherals interface 761, a power system 795, and memory (e.g., a memory 780), each of which are defined above and described in more detail below.

The power system 795 can include a charger input 796, a power-management integrated circuit (PMIC) 797, and a battery 798, each of which are defined above. In some embodiments, a watch body 720 and a wearable band 710 can have respective charger inputs (e.g., charger inputs 796 and 757), respective batteries (e.g., batteries 798 and 759), and can share power with each other (e.g., the watch body 720 can power and/or charge the wearable band 710 and vice versa). Although watch body 720 and/or the wearable band 710 can include respective charger inputs, a single charger input can charge both devices when coupled. The watch body 720 and the wearable band 710 can receive a charge using a variety of techniques. In some embodiments, the watch body 720 and the wearable band 710 can use a wired charging assembly (e.g., power cords) to receive the charge. Alternatively, or in addition, the watch body 720 and/or the wearable band 710 can be configured for wireless charging. For example, a portable charging device can be designed to mate with a portion of watch body 720 and/or wearable band 710 and wirelessly deliver usable power to a battery of watch body 720 and/or wearable band 710. The watch body 720 and the wearable band 710 can have independent power systems (e.g., power system 795 and 756) to enable each to operate independently. The watch body 720 and wearable band 710 can also share power (e.g., one can charge the other) via respective PMICs (e.g., PMICs 797 and 758) that can share power over power and ground conductors and/or over wireless charging antennas.

In some embodiments, the peripherals interface 761 can include one or more sensors 721, many of which listed below are defined above. The sensors 721 can include one or more coupling sensors 762 for detecting when the watch body 720 is coupled with another electronic device (e.g., a wearable band 710). The sensors 721 can include imaging sensors 763 (one or more of the cameras 725 and/or separate imaging sensors 763 (e.g., thermal-imaging sensors)). In some embodiments, the sensors 721 include one or more SpO2 sensors 764. In some embodiments, the sensors 721 include one or more biopotential-signal sensors (e.g., EMG sensors 765, which may be disposed on a user-facing portion of the watch body 720 and/or the wearable band 710). In some embodiments, the sensors 721 include one or more capacitive sensors 766. In some embodiments, the sensors 721 include one or more heart rate sensors 767. In some embodiments, the sensors 721 include one or more IMUs 768. In some embodiments, one or more IMUs 768 can be configured to detect movement of a user's hand or other location that the watch body 720 is placed or held.

In some embodiments, the peripherals interface 761 includes an NFC component 769, a GPS component 770, a long-term evolution (LTE) component 771, and/or a Wi-Fi and/or Bluetooth communication component 772. In some embodiments, the peripherals interface 761 includes one or more buttons 773 (e.g., the peripheral buttons 723 and 727 in FIG. 7A), which, when selected by a user, cause operations to be performed at the watch body 720. In some embodiments, the peripherals interface 761 includes one or more indicators, such as a light-emitting diode (LED), to provide a user with visual indicators (e.g., message received, low battery, an active microphone, and/or a camera).

The watch body 720 can include at least one display 705 for displaying visual representations of information or data to the user, including user-interface elements and/or three-dimensional (3D) virtual objects. The display can also include a touch screen for inputting user inputs, such as touch gestures, swipe gestures, and the like. The watch body 720 can include at least one speaker 774 and at least one microphone 775 for providing audio signals to the user and receiving audio input from the user. The user can provide user inputs through the microphone 775 and can also receive audio output from the speaker 774 as part of a haptic event provided by the haptic controller 778. The watch body 720 can include at least one camera 725, including a front-facing camera 725a and a rear-facing camera 725b. The cameras 725 can include ultra-wide-angle cameras, wide-angle cameras, fish-eye cameras, spherical cameras, telephoto cameras, depth-sensing cameras, or other types of cameras.

The watch body computing system 760 can include one or more haptic controllers 778 and associated componentry (e.g., haptic devices 776) for providing haptic events at the watch body 720 (e.g., a vibrating sensation or audio output in response to an event at the watch body 720). The haptic controllers 778 can communicate with one or more haptic devices 776, such as electroacoustic devices, including a speaker of the one or more speakers 774 and/or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). The haptic controller 778 can provide haptic events to respective haptic actuators that are capable of being sensed by a user of the watch body 720. In some embodiments, the one or more haptic controllers 778 can receive input signals from an application of the applications 782.

In some embodiments, the wearable band computer system 730 and/or the watch body computing system 760 can include memory 780, which can be controlled by a memory controller of the one or more controllers 777 and/or one or more processors 779. In some embodiments, software components stored in the memory 780 include one or more applications 782 configured to perform operations at the watch body 720. In some embodiments, the one or more applications 782 include games, word processors, messaging applications, calling applications, web browsers, social media applications, media streaming applications, financial applications, calendars, clocks, etc. In some embodiments, software components stored in the memory 780 include one or more communication interface modules 783 as defined above. In some embodiments, software components stored in the memory 780 include one or more graphics modules 784 for rendering, encoding, and/or decoding audio and/or visual data; and one or more data management modules 785 for collecting, organizing, and/or providing access to the data 787 stored in memory 780. In some embodiments, software components stored in the memory 780 include a disparity correction module 786A, which is configured to perform the features described above in reference to FIGS. 1-5. In some embodiments, one or more of applications 782 and/or one or more modules can work in conjunction with one another to perform various tasks at the watch body 720.

In some embodiments, software components stored in the memory 780 can include one or more operating systems 781 (e.g., a Linux-based operating system, an Android operating system, etc.). The memory 780 can also include data 787. The data 787 can include profile data 788A, sensor data 789A, media content data 790, application data 791, and disparity correction data 792A, which stores data related to the performance of the features described above in reference to FIGS. 1-5.

It should be appreciated that the watch body computing system 760 is an example of a computing system within the watch body 720, and that the watch body 720 can have more or fewer components than shown in the watch body computing system 760, combine two or more components, and/or have a different configuration and/or arrangement of the components. The various components shown in watch body computing system 760 are implemented in hardware, software, firmware, or a combination thereof, including one or more signal processing and/or application-specific integrated circuits.

Turning to the wearable band computing system 730, one or more components that can be included in the wearable band 710 are shown. The wearable band computing system 730 can include more or fewer components than shown in the watch body computing system 760, combine two or more components, and/or have a different configuration and/or arrangement of some or all of the components. In some embodiments, all, or a substantial portion of the components of the wearable band computing system 730 are included in a single integrated circuit. Alternatively, in some embodiments, components of the wearable band computing system 730 are included in a plurality of integrated circuits that are communicatively coupled. As described above, in some embodiments, the wearable band computing system 730 is configured to couple (e.g., via a wired or wireless connection) with the watch body computing system 760, which allows the computing systems to share components, distribute tasks, and/or perform other operations described herein (individually or as a single device).

The wearable band computing system 730, similar to the watch body computing system 760, can include one or more processors 749, one or more controllers 747 (including one or more haptics controller 748), a peripherals interface 731 that can include one or more sensors 713 and other peripheral devices, power source (e.g., a power system 756), and memory (e.g., a memory 750) that includes an operating system (e.g., an operating system 751), data (e.g., data 754 including profile data 788B, sensor data 789B, disparity correction data 792B, etc.), and one or more modules (e.g., a communications interface module 752, a data management module 753, a disparity correction module 786B, etc.).

The one or more sensors 713 can be analogous to sensors 721 of the watch body computing system 760 in light of the definitions above. For example, sensors 713 can include one or more coupling sensors 732, one or more SpO2 sensors 734, one or more EMG sensors 735, one or more capacitive sensors 736, one or more heart rate sensors 737, and one or more IMU sensors 738.

The peripherals interface 731 can also include other components analogous to those included in the peripheral interface 761 of the watch body computing system 760, including an NFC component 739, a GPS component 740, an LTE component 741, a Wi-Fi and/or Bluetooth communication component 742, and/or one or more haptic devices 776 as described above in reference to peripherals interface 761. In some embodiments, the peripherals interface 731 includes one or more buttons 743, a display 733, a speaker 744, a microphone 745, and a camera 755. In some embodiments, the peripherals interface 731 includes one or more indicators, such as an LED.

It should be appreciated that the wearable band computing system 730 is an example of a computing system within the wearable band 710, and that the wearable band 710 can have more or fewer components than shown in the wearable band computing system 730, combine two or more components, and/or have a different configuration and/or arrangement of the components. The various components shown in wearable band computing system 730 can be implemented in one or a combination of hardware, software, and firmware, including one or more signal processing and/or application-specific integrated circuits.

The wrist-wearable device 700 with respect to FIG. 7A is an example of the wearable band 710 and the watch body 720 coupled, so the wrist-wearable device 700 will be understood to include the components shown and described for the wearable band computing system 730 and the watch body computing system 760. In some embodiments, wrist-wearable device 700 has a split architecture (e.g., a split mechanical architecture or a split electrical architecture) between the watch body 720 and the wearable band 710. In other words, all of the components shown in the wearable band computing system 730 and the watch body computing system 760 can be housed or otherwise disposed in a combined wrist-wearable device 700, or within individual components of the watch body 720, wearable band 710, and/or portions thereof (e.g., a coupling mechanism 716 of the wearable band 710).

The techniques described above can be used with any device for sensing neuromuscular signals, including the arm-wearable devices of FIG. 7A-7B, but could also be used with other types of wearable devices for sensing neuromuscular signals (such as body-wearable or head-wearable devices that might have neuromuscular sensors closer to the brain or spinal column).

In some embodiments, a wrist-wearable device 700 can be used in conjunction with a head-wearable device described below (e.g., AR device 800 and VR device 810) and/or an HIPD 900, and the wrist-wearable device 700 can also be configured to be used to allow a user to control aspect of the artificial reality (e.g., by using EMG-based gestures to control user interface objects in the artificial reality and/or by allowing a user to interact with the touchscreen on the wrist-wearable device to also control aspects of the artificial reality. In some embodiments, a wrist-wearable device 700 can also be used in conjunction with a wearable garment, such as smart textile-based garment 652 (FIG. 6D-1). Having thus described example wrist-wearable device, attention will now be turned to example head-wearable devices, such AR device 800 and VR device 810.

### Example Head-Wearable Devices

FIGS. 8A, 8B-1, 8B-2, and 8C show example head-wearable devices, in accordance with some embodiments. Head-wearable devices can include, but are not limited to, AR devices 800 (e.g., AR or smart eyewear devices, such as smart glasses, smart monocles, smart contacts, etc.), VR devices 810 (e.g., VR headsets or head-mounted displays (HMDs)), or other ocularly coupled devices. The AR devices 800 and the VR devices 810 are instances of the head-wearable devices, more specifically to the AR glasses, described in reference to FIGS. 1-5 herein, such that the head-wearable device should be understood to have the features of the AR devices 800 and/or the VR devices 810 and vice versa. The AR devices 800 and the VR devices 810 can perform various functions and/or operations associated with navigating through user interfaces and selectively opening applications, as well as the functions and/or operations described above with reference to FIGS. 1-5.

In some embodiments, an AR system (e.g., FIGS. 6A-6D-2; AR systems 600a-600d) includes an AR device 800 (as shown in FIG. 8A) and/or VR device 810 (as shown in FIGS. 8B-1-B-2). In some embodiments, the AR device 800 and the VR device 810 can include one or more analogous components (e.g., components for presenting interactive AR environments, such as processors, memory, and/or presentation devices, including one or more displays and/or one or more waveguides), some of which are described in more detail with respect to FIG. 8C. The head-wearable devices can use display projectors (e.g., display projector assemblies 807A and 807B) and/or waveguides for projecting representations of data to a user. Some embodiments of head-wearable devices do not include displays.

FIG. 8A shows an example visual depiction of the AR device 800 (e.g., which may also be described herein as artificial-reality glasses and/or smart glasses). The AR device 800 can work in conjunction with additional electronic components that are not shown in FIGS. 8A, such as a wearable accessory device and/or an intermediary processing device, in electronic communication or otherwise configured to be used in conjunction with the AR device 800. In some embodiments, the wearable accessory device and/or the intermediary processing device may be configured to couple with the AR device 800 via a coupling mechanism in electronic communication with a coupling sensor 824, where the coupling sensor 824 can detect when an electronic device becomes physically or electronically coupled with the AR device 800. In some embodiments, the AR device 800 can be configured to couple to a housing (e.g., a portion of frame 804 or temple arms 805), which may include one or more additional coupling mechanisms configured to couple with additional accessory devices. The components shown in FIG. 8A can be implemented in hardware, software, firmware, or a combination thereof, including one or more signal-processing components and/or application-specific integrated circuits (ASICs).

The AR device 800 includes mechanical glasses components, including a frame 804 configured to hold one or more lenses (e.g., one or both lenses 806-1 and 806-2). One of ordinary skill in the art will appreciate that the AR device 800 can include additional mechanical components, such as hinges configured to allow portions of the frame 804 of the AR device 800 to be folded and unfolded, a bridge configured to span the gap between the lenses 806-1 and 806-2 and rest on the user's nose, nose pads configured to rest on the bridge of the nose and provide support for the AR device 800, earpieces configured to rest on the user's ears and provide additional support for the AR device 800, temple arms 805 configured to extend from the hinges to the earpieces of the AR device 800, and the like. One of ordinary skill in the art will further appreciate that some examples of the AR device 800 can include none of the mechanical components described herein. For example, smart contact lenses configured to present AR to users may not include any components of the AR device 800.

The lenses 806-1 and 806-2 can be individual displays or display devices (e.g., a waveguide for projected representations). The lenses 806-1 and 806-2 may act together or independently to present an image or series of images to a user. In some embodiments, the lenses 806-1 and 806-2 can operate in conjunction with one or more display projector assemblies 807A and 807B to present image data to a user. While the AR device 800 includes two displays, embodiments of this disclosure may be implemented in AR devices with a single near-eye display (NED) or more than two NEDs.

The AR device 800 includes electronic components, many of which will be described in more detail below with respect to FIG. 8C. Some example electronic components are illustrated in FIG. 8A, including sensors 823-1, 823-2, 823-3, 823-4, 823-5, and 823-6, which can be distributed along a substantial portion of the frame 804 of the AR device 800. The different types of sensors are described below in reference to FIG. 8C. The AR device 800 also includes a left camera 839A and a right camera 839B, which are located on different sides of the frame 804. And the eyewear device includes one or more processors 848A and 848B (e.g., an integral microprocessor, such as an ASIC) that is embedded into a portion of the frame 804.

FIGS. 8B-1 and 8B-2 show an example visual depiction of the VR device 810 (e.g., a head-mounted display (HMD) 812, also referred to herein as an AR headset, a head-wearable device, or a VR headset). The HMD 812 includes a front body 814 and a frame 816 (e.g., a strap or band) shaped to fit around a user's head. In some embodiments, the front body 814 and/or the frame 816 includes one or more electronic elements for facilitating presentation of and/or interactions with an AR and/or VR system (e.g., displays, processors (e.g., processor 848A-1), IMUs, tracking emitters or detectors, or sensors). In some embodiments, the HMD 812 includes output audio transducers (e.g., an audio transducer 818-1), as shown in FIG. 8B-2. In some embodiments, one or more components, such as the output audio transducer(s) 818 and the frame 816, can be configured to attach and detach (e.g., are detachably attachable) to the HMD 812 (e.g., a portion or all of the frame 816 and/or the output audio transducer 818), as shown in FIG. 8B-2. In some embodiments, coupling a detachable component to the HMD 812 causes the detachable component to come into electronic communication with the HMD 812. The VR device 810 includes electronic components, many of which will be described in more detail below with respect to FIG. 8C.

FIGS. 8B-1 and 8B-2 also show that the VR device 810 having one or more cameras, such as the left camera 839A and the right camera 839B, which can be analogous to the left and right cameras on the frame 804 of the AR device 800. In some embodiments, the VR device 810 includes one or more additional cameras (e.g., cameras 839C and 839D), which can be configured to augment image data obtained by the cameras 839A and 839B by providing more information. For example, the camera 839C can be used to supply color information that is not discerned by cameras 839A and 839B. In some embodiments, one or more of the cameras 839A to 839D can include an optional IR (infrared) cut filter configured to remove IR light from being received at the respective camera sensors.

The VR device 810 can include a housing 890 storing one or more components of the VR device 810 and/or additional components of the VR device 810. The housing 890 can be a modular electronic device configured to couple with the VR device 810 (or an AR device 800) and supplement and/or extend the capabilities of the VR device 810 (or an AR device 800). For example, the housing 890 can include additional sensors, cameras, power sources, and processors (e.g., processor 848A-2). to improve and/or increase the functionality of the VR device 810. Examples of the different components included in the housing 890 are described below in reference to FIG. 8C.

Alternatively, or in addition, in some embodiments, the head-wearable device, such as the VR device 810 and/or the AR device 800, includes, or is communicatively coupled to, another external device (e.g., a paired device), such as an HIPD 9 (discussed below in reference to FIGS. 9A-9B) and/or an optional neckband. The optional neckband can couple to the head-wearable device via one or more connectors (e.g., wired or wireless connectors). The head-wearable device and the neckband can operate independently without any wired or wireless connection between them. In some embodiments, the components of the head-wearable device and the neckband are located on one or more additional peripheral devices paired with the head-wearable device, the neckband, or some combination thereof. Furthermore, the neckband is intended to represent any suitable type or form of paired device. Thus, the following discussion of neckbands may also apply to various other paired devices, such as smartwatches, smartphones, wrist bands, other wearable devices, hand-held controllers, tablet computers, or laptop computers.

In some situations, pairing external devices, such as an intermediary processing device (e.g., an HIPD device 900, an optional neckband, and/or a wearable accessory device) with the head-wearable devices (e.g., an AR device 800 and/or a VR device 810) enables the head-wearable devices to achieve a similar form factor of a pair of glasses while still providing sufficient battery and computational power for expanded capabilities. Some, or all, of the battery power, computational resources, and/or additional features of the head-wearable devices can be provided by a paired device or shared between a paired device and the head-wearable devices, thus reducing the weight, heat profile, and form factor of the head-wearable device overall while allowing the head-wearable device to retain its desired functionality. For example, the intermediary processing device (e.g., the HIPD 900) can allow components that would otherwise be included in a head-wearable device to be included in the intermediary processing device (and/or a wearable device or accessory device), thereby shifting a weight load from the user's head and neck to one or more other portions of the user's body. In some embodiments, the intermediary processing device has a larger surface area over which to diffuse and disperse heat to the ambient environment. Thus, the intermediary processing device can allow for greater battery and computational capacity than might otherwise have been possible on the head-wearable devices, standing alone. Because weight carried in the intermediary processing device can be less invasive to a user than weight carried in the head-wearable devices, a user may tolerate wearing a lighter eyewear device and carrying or wearing the paired device for greater lengths of time than the user would tolerate wearing a heavier eyewear device standing alone, thereby enabling an AR environment to be incorporated more fully into a user's day-to-day activities.

In some embodiments, the intermediary processing device is communicatively coupled with the head-wearable device and/or to other devices. The other devices may provide certain functions (e.g., tracking, localizing, depth mapping, processing, and/or storage) to the head-wearable device. In some embodiments, the intermediary processing device includes a controller and a power source. In some embodiments, sensors of the intermediary processing device are configured to sense additional data that can be shared with the head-wearable devices in an electronic format (analog or digital).

The controller of the intermediary processing device processes information generated by the sensors on the intermediary processing device and/or the head-wearable devices. The intermediary processing device, such as an HIPD 900, can process information generated by one or more of its sensors and/or information provided by other communicatively coupled devices. For example, a head-wearable device can include an IMU, and the intermediary processing device (a neckband and/or an HIPD 900) can compute all inertial and spatial calculations from the IMUs located on the head-wearable device. Additional examples of processing performed by a communicatively coupled device, such as the HIPD 900, are provided below in reference to FIGS. 9A and 9B.

AR systems may include a variety of types of visual feedback mechanisms. For example, display devices in the AR devices 800 and/or the VR devices 810 may include one or more liquid-crystal displays (LCDs), light-emitting diode (LED) displays, organic LED (OLED) displays, and/or any other suitable type of display screen. AR systems may include a single display screen for both eyes or may provide a display screen for each eye, which may allow for additional flexibility for varifocal adjustments or for correcting a refractive error associated with the user's vision. Some AR systems also include optical subsystems having one or more lenses (e.g., conventional concave or convex lenses, Fresnel lenses, or adjustable liquid lenses) through which a user may view a display screen. In addition to or instead of using display screens, some AR systems include one or more projection systems. For example, display devices in the AR device 800 and/or the VR device 810 may include micro-LED projectors that project light (e.g., using a waveguide) into display devices, such as clear combiner lenses that allow ambient light to pass through. The display devices may refract the projected light toward a user's pupil and may enable a user to simultaneously view both AR content and the real world. AR systems may also be configured with any other suitable type or form of image projection system. As noted, some AR systems may, instead of blending an artificial reality with actual reality, substantially replace one or more of a user's sensory perceptions of the real world with a virtual experience.

While the example head-wearable devices are respectively described herein as the AR device 800 and the VR device 810, either or both of the example head-wearable devices described herein can be configured to present fully immersive VR scenes presented in substantially all of a user's field of view, additionally or alternatively to, subtler artificial-reality scenes that are presented within a portion, less than all, of the user's field of view.

In some embodiments, the AR device 800 and/or the VR device 810 can include haptic feedback systems. The haptic feedback systems may provide various types of cutaneous feedback, including vibration, force, traction, shear, texture, and/or temperature. The haptic feedback systems may also provide various types of kinesthetic feedback, such as motion and compliance. The haptic feedback can be implemented using motors, piezoelectric actuators, fluidic systems, and/or a variety of other types of feedback mechanisms. The haptic feedback systems may be implemented independently of other AR devices, within other AR devices, and/or in conjunction with other AR devices (e.g., wrist-wearable devices that may be incorporated into headwear, gloves, body suits, handheld controllers, environmental devices (e.g., chairs or floormats), and/or any other type of device or system, such as a wrist-wearable device 700, an HIPD 900, smart textile-based garment 652), and/or other devices described herein.

FIG. 8C illustrates a computing system 820 and an optional housing 890, each of which shows components that can be included in a head-wearable device (e.g., the AR device 800 and/or the VR device 810). In some embodiments, more or fewer components can be included in the optional housing 890 depending on practical restraints of the respective head-wearable device being described. Additionally or alternatively, the optional housing 890 can include additional components to expand and/or augment the functionality of a head-wearable device.

In some embodiments, the computing system 820 and/or the optional housing 890 can include one or more peripheral interfaces 822A and 822B, one or more power systems 842A and 842B (including charger input 843, PMIC 844, and battery 845), one or more controllers 846A and 846B (including one or more haptic controllers 847), one or more processors 848A and 848B (as defined above, including any of the examples provided), and memory 850A and 850B, which can all be in electronic communication with each other. For example, the one or more processors 848A and/or 848B can be configured to execute instructions stored in the memory 850A and/or 850B, which can cause a controller of the one or more controllers 846A and/or 846B to cause operations to be performed at one or more peripheral devices of the peripherals interfaces 822A and/or 822B. In some embodiments, each operation described can occur based on electrical power provided by the power system 842A and/or 842B.

In some embodiments, the peripherals interface 822A can include one or more devices configured to be part of the computing system 820, many of which have been defined above and/or described with respect to wrist-wearable devices shown in FIGS. 7A and 7B. For example, the peripherals interface can include one or more sensors 823A. Some example sensors include one or more coupling sensors 824, one or more acoustic sensors 825, one or more light sensors 826, one or more EMG sensors 827, one or more capacitive sensors 828, and/or one or more IMUs 829. In some embodiments, the sensors 823A further include depth sensors 867, light sensors 868, and/or any other types of sensors defined above or described with respect to any other embodiments discussed herein.

In some embodiments, the peripherals interface can include one or more additional peripheral devices, including one or more NFC devices 830, one or more GPS devices 831, one or more LTE devices 832, one or more Wi-Fi and/or Bluetooth devices 833, one or more buttons 834 (e.g., including buttons that are slidable or otherwise adjustable), one or more displays 835A, one or more speakers 836A, one or more microphones 837A, one or more cameras 838A (e.g., including the camera 839-1 through nth camera 839-n, which are analogous to the left camera 839A and/or the right camera 839B), one or more haptic devices 840, and/or any other types of peripheral devices defined above or described with respect to any other embodiments discussed herein.

The head-wearable devices can include a variety of types of visual feedback mechanisms (e.g., presentation devices). For example, display devices in the AR device 800 and/or the VR device 810 can include one or more liquid-crystal displays (LCDs), light-emitting diode (LED) displays, organic LED (OLED) displays, micro-LEDs, and/or any other suitable types of display screens. The head-wearable devices can include a single display screen (e.g., configured to be seen by both eyes) and/or can provide separate display screens for each eye, which can allow for additional flexibility for varifocal adjustments and/or for correcting a refractive error associated with the user's vision. Some embodiments of the head-wearable devices also include optical subsystems having one or more lenses (e.g., conventional concave or convex lenses, Fresnel lenses, or adjustable liquid lenses) through which a user can view a display screen. For example, respective displays 835A can be coupled to each of the lenses 806-1 and 806-2 of the AR device 800. The displays 835A coupled to each of the lenses 806-1 and 806-2 can act together or independently to present an image or series of images to a user. In some embodiments, the AR device 800 and/or the VR device 810 includes a single display 835A (e.g., a near-eye display) or more than two displays 835A.

In some embodiments, a set of one or more displays 835A can be used to present an artificial-reality environment, and a set of one or more display devices 835A can be used to present a VR environment. In some embodiments, one or more waveguides are used in conjunction with presenting AR content to the user of the AR device 800 and/or the VR device 810 (e.g., as a means of delivering light from a display projector assembly and/or one or more displays 835A to the user's eyes). In some embodiments, one or more waveguides are fully or partially integrated into the AR device 800 and/or the VR device 810. Additionally, or alternatively, to display screens, some AR systems include one or more projection systems. For example, display devices in the AR device 800 and/or the VR device 810 can include micro-LED projectors that project light (e.g., using a waveguide) into display devices, such as clear combiner lenses that allow ambient light to pass through. The display devices can refract the projected light toward a user's pupil and can enable a user to simultaneously view both AR content and the real world. The head-wearable devices can also be configured with any other suitable type or form of image projection system. In some embodiments, one or more waveguides are provided, additionally or alternatively, to the one or more display(s) 835A.

In some embodiments of the head-wearable devices, ambient light and/or a real-world live view (e.g., a live feed of the surrounding environment that a user would normally see) can be passed through a display element of a respective head-wearable device presenting aspects of the AR system. In some embodiments, ambient light and/or the real-world live view can be passed through a portion, less than all, of an AR environment presented within a user's field of view (e.g., a portion of the AR environment co-located with a physical object in the user's real-world environment that is within a designated boundary (e.g., a guardian boundary) configured to be used by the user while they are interacting with the AR environment). For example, a visual user interface element (e.g., a notification user interface element) can be presented at the head-wearable devices, and an amount of ambient light and/or the real-world live view (e.g., 15%-50% of the ambient light and/or the real-world live view) can be passed through the user interface element, such that the user can distinguish at least a portion of the physical environment over which the user interface element is being displayed.

The head-wearable devices can include one or more external displays 835A for presenting information to users. For example, an external display 835A can be used to show a current battery level, network activity (e.g., connected, disconnected), current activity (e.g., playing a game, in a call, in a meeting, or watching a movie), and/or other relevant information. In some embodiments, the external displays 835A can be used to communicate with others. For example, a user of the head-wearable device can cause the external displays 835A to present a “do not disturb” notification. The external displays 835A can also be used by the user to share any information captured by the one or more components of the peripherals interface 822A and/or generated by the head-wearable device (e.g., during operation and/or performance of one or more applications).

The memory 850A can include instructions and/or data executable by one or more processors 848A (and/or processors 848B of the housing 890) and/or a memory controller of the one or more controllers 846A (and/or controller 846B of the housing 890). The memory 850A can include one or more operating systems 851, one or more applications 852, one or more communication interface modules 853A, one or more graphics modules 854A, one or more AR processing modules 855A, a disparity correction module 856A (analogous to the disparity correction modules 786A and 786B; FIG. 7B), and/or any other types of modules or components defined above or described with respect to any other embodiments discussed herein.

The data 860 stored in memory 850A can be used in conjunction with one or more of the applications and/or programs discussed above. The data 860 can include profile data 861, sensor data 862, media content data 863, AR application data 864, disparity correction data 865 (analogous to the disparity correction data 792A and 792B; FIG. 7B) for storing data related to the performance of the features described above in reference to FIGS. 1-5, and/or any other types of data defined above or described with respect to any other embodiments discussed herein.

In some embodiments, the controller 846A of the head-wearable devices processes information generated by the sensors 823A on the head-wearable devices and/or another component of the head-wearable devices and/or communicatively coupled with the head-wearable devices (e.g., components of the housing 890, such as components of peripherals interface 822B). For example, the controller 846A can process information from the acoustic sensors 825 and/or light sensors 826. For each detected sound, the controller 846A can perform a direction of arrival (DOA) estimation to estimate a direction from which the detected sound arrived at a head-wearable device. As one or more of the acoustic sensors 825 detect sounds, the controller 846A can populate an audio data set with the information (e.g., represented by sensor data 862).

In some embodiments, a physical electronic connector can convey information between the head-wearable devices and another electronic device, and/or between one or more processors 848A of the head-wearable devices and the controller 846A. The information can be in the form of optical data, electrical data, wireless data, or any other transmittable data form. Moving the processing of information generated by the head-wearable devices to an intermediary processing device can reduce weight and heat in the eyewear device, making it more comfortable and safer for a user. In some embodiments, an optional accessory device (e.g., an electronic neckband or an HIPD 900) is coupled to the head-wearable devices via one or more connectors. The connectors can be wired or wireless connectors and can include electrical and/or non-electrical (e.g., structural) components. In some embodiments, the head-wearable devices and the accessory device can operate independently without any wired or wireless connection between them.

The head-wearable devices can include various types of computer vision components and subsystems. For example, the AR device 800 and/or the VR device 810 can include one or more optical sensors such as two-dimensional (2D) or three-dimensional (3D) cameras, ToF depth sensors, single-beam or sweeping laser rangefinders, 3D LiDAR sensors, and/or any other suitable type or form of optical sensor. A head-wearable device can process data from one or more of these sensors to identify a location of a user and/or aspects of the user's real-world physical surroundings, including the locations of real-world objects within the real-world physical surroundings. In some embodiments, the methods described herein are used to map the real world, to provide a user with context about real-world surroundings, and/or to generate interactable virtual objects (which can be replicas or digital twins of real-world objects that can be interacted with an AR environment), among a variety of other functions. For example, FIGS. 8B-1 and 8B-2 show the VR device 810 having cameras 839A-839D, which can be used to provide depth information for creating a voxel field and a 2D mesh to provide object information to the user to avoid collisions.

The optional housing 890 can include analogous components to those describe above with respect to the computing system 820. For example, the optional housing 890 can include a respective peripherals interface 822B, including more or fewer components to those described above with respect to the peripherals interface 822A. As described above, the components of the optional housing 890 can be used to augment and/or expand on the functionality of the head-wearable devices. For example, the optional housing 890 can include respective sensors 823B, speakers 836B, displays 835B, microphones 837B, cameras 838B, and/or other components to capture and/or present data. Similarly, the optional housing 890 can include one or more processors 848B, controllers 846B, and/or memory 850B (including respective communication interface modules 853B, one or more graphics modules 854B, one or more AR processing modules 855B, and a disparity correction module 856B (analogous to the disparity correction modules 786A and 786B; FIG. 7B)) that can be used individually and/or in conjunction with the components of the computing system 820.

The techniques described above in FIGS. 8A-8C can be used with different head-wearable devices. In some embodiments, the head-wearable devices (e.g., the AR device 800 and/or the VR device 810) can be used in conjunction with one or more wearable devices such as a wrist-wearable device 700 (or components thereof) and/or a smart textile-based garment 652 (FIG. 6D-1), as well as an HIPD 900. Having thus described example the head-wearable devices, attention will now be turned to example handheld intermediary processing devices, such as HIPD 900.

### Example Handheld Intermediary Processing Devices

FIGS. 9A and 9B illustrate an example handheld intermediary processing device (HIPD) 900, in accordance with some embodiments. The HIPD 900 can perform various functions and/or operations associated with navigating through user interfaces and selectively opening applications, as well as the functions and/or operations described above with reference to FIGS. 1-5.

FIG. 9A shows a top view 905 and a side view 925 of the HIPD 900. The HIPD 900 is configured to communicatively couple with one or more wearable devices (or other electronic devices) associated with a user. For example, the HIPD 900 is configured to communicatively couple with a user's wrist-wearable device 700 (or components thereof, such as the watch body 720 and the wearable band 710), AR device 800, and/or VR device 810. The HIPD 900 can be configured to be held by a user (e.g., as a handheld controller), carried on the user's person (e.g., in their pocket, in their bag, etc.), placed in proximity of the user (e.g., placed on their desk while seated at their desk, on a charging dock, etc.), and/or placed at or within a predetermined distance from a wearable device or other electronic device (e.g., where, in some embodiments, the predetermined distance is the maximum distance (e.g., 10 meters) at which the HIPD 900 can successfully be communicatively coupled with an electronic device, such as a wearable device).

The HIPD 900 can perform various functions independently and/or in conjunction with one or more wearable devices (e.g., wrist-wearable device 700, AR device 800, VR device 810, etc.). The HIPD 900 is configured to increase and/or improve the functionality of communicatively coupled devices, such as the wearable devices. The HIPD 900 is configured to perform one or more functions or operations associated with interacting with user interfaces and applications of communicatively coupled devices, interacting with an AR environment, interacting with VR environment, and/or operating as a human-machine interface controller, as well as functions and/or operations described above with reference to FIGS. 1-5. Additionally, as will be described in more detail below, functionality and/or operations of the HIPD 900 can include, without limitation, task offloading and/or handoffs; thermals offloading and/or handoffs; 6 degrees of freedom (6DoF) raycasting and/or gaming (e.g., using imaging devices or cameras 914A and 914B, which can be used for simultaneous localization and mapping (SLAM) and/or with other image processing techniques); portable charging; messaging; image capturing via one or more imaging devices or cameras (e.g., cameras 922A and 922B); sensing user input (e.g., sensing a touch on a multi-touch input surface 902); wireless communications and/or interlining (e.g., cellular, near field, Wi-Fi, personal area network, etc.); location determination; financial transactions; providing haptic feedback; alarms; notifications; biometric authentication; health monitoring; sleep monitoring; etc. The above-example functions can be executed independently in the HIPD 900 and/or in communication between the HIPD 900 and another wearable device described herein. In some embodiments, functions can be executed on the HIPD 900 in conjunction with an AR environment. As the skilled artisan will appreciate upon reading the descriptions provided herein, the novel the HIPD 900 described herein can be used with any type of suitable AR environment.

While the HIPD 900 is communicatively coupled with a wearable device and/or other electronic device, the HIPD 900 is configured to perform one or more operations initiated at the wearable device and/or the other electronic device. In particular, one or more operations of the wearable device and/or the other electronic device can be offloaded to the HIPD 900 to be performed. The HIPD 900 performs the one or more operations of the wearable device and/or the other electronic device and provides to data corresponded to the completed operations to the wearable device and/or the other electronic device. For example, a user can initiate a video stream using AR device 800 and back-end tasks associated with performing the video stream (e.g., video rendering) can be offloaded to the HIPD 900, which the HIPD 900 performs and provides corresponding data to the AR device 800 to perform remaining front-end tasks associated with the video stream (e.g., presenting the rendered video data via a display of the AR device 800). In this way, the HIPD 900, which has more computational resources and greater thermal headroom than a wearable device, can perform computationally intensive tasks for the wearable device improving performance of an operation performed by the wearable device.

The HIPD 900 includes a multi-touch input surface 902 on a first side (e.g., a front surface) that is configured to detect one or more user inputs. In particular, the multi-touch input surface 902 can detect single tap inputs, multi-tap inputs, swipe gestures and/or inputs, force-based and/or pressure-based touch inputs, held taps, and the like. The multi-touch input surface 902 is configured to detect capacitive touch inputs and/or force (and/or pressure) touch inputs. The multi-touch input surface 902 includes a touch-input surface 904 defined by a surface depression, and a touch-input surface 906 defined by a substantially planar portion. The touch-input surface 904 can be disposed adjacent to the touch-input surface 906. In some embodiments, the touch-input surface 904 and the touch-input surface 906 can be different dimensions, shapes, and/or cover different portions of the multi-touch input surface 902. For example, the touch-input surface 904 can be substantially circular and the touch-input surface 906 is substantially rectangular. In some embodiments, the surface depression of the multi-touch input surface 902 is configured to guide user handling of the HIPD 900. In particular, the surface depression is configured such that the user holds the HIPD 900 upright when held in a single hand (e.g., such that the using imaging devices or cameras 914A and 914B are pointed toward a ceiling or the sky). Additionally, the surface depression is configured such that the user's thumb rests within the touch-input surface 904.

In some embodiments, the different touch-input surfaces include a plurality of touch-input zones. For example, the touch-input surface 906 includes at least a touch-input zone 908 within a touch-input surface 906 and a third touch-input zone 910 within the touch-input zone 908. In some embodiments, one or more of the touch-input zones are optional and/or user defined (e.g., a user can specific a touch-input zone based on their preferences). In some embodiments, each touch-input surface and/or touch-input zone is associated with a predetermined set of commands. For example, a user input detected within the touch-input zone 908 causes the HIPD 900 to perform a first command and a user input detected within the touch-input surface 906 causes the HIPD 900 to perform a second command, distinct from the first. In some embodiments, different touch-input surfaces and/or touch-input zones are configured to detect one or more types of user inputs. The different touch-input surfaces and/or touch-input zones can be configured to detect the same or distinct types of user inputs. For example, the touch-input zone 908 can be configured to detect force touch inputs (e.g., a magnitude at which the user presses down) and capacitive touch inputs, and the touch-input surface 906 can be configured to detect capacitive touch inputs.

The HIPD 900 includes one or more sensors 951 for sensing data used in the performance of one or more operations and/or functions. For example, the HIPD 900 can include an IMU that is used in conjunction with cameras 914 for 3-dimensional object manipulation (e.g., enlarging, moving, destroying, etc. an object) in an AR or VR environment. Non-limiting examples of the sensors 951 included in the HIPD 900 include a light sensor, a magnetometer, a depth sensor, a pressure sensor, and a force sensor. Additional examples of the sensors 951 are provided below in reference to FIG. 9B.

The HIPD 900 can include one or more light indicators 912 to provide one or more notifications to the user. In some embodiments, the light indicators are LEDs or other types of illumination devices. The light indicators 912 can operate as a privacy light to notify the user and/or others near the user that an imaging device and/or microphone are active. In some embodiments, a light indicator is positioned adjacent to one or more touch-input surfaces. For example, a light indicator can be positioned around the touch-input surface 904. The light indicators can be illuminated in different colors and/or patterns to provide the user with one or more notifications and/or information about the device. For example, a light indicator positioned around the touch-input surface 904 can flash when the user receives a notification (e.g., a message), change red when the HIPD 900 is out of power, operate as a progress bar (e.g., a light ring that is closed when a task is completed (e.g., 0% to 100%)), operates as a volume indicator, etc.).

In some embodiments, the HIPD 900 includes one or more additional sensors on another surface. For example, as shown FIG. 9A, HIPD 900 includes a set of one or more sensors (e.g., sensor set 920) on an edge of the HIPD 900. The sensor set 920, when positioned on an edge of the of the HIPD 900, can be positioned at a predetermined tilt angle (e.g., 26 degrees), which allows the sensor set 920 to be angled toward the user when placed on a desk or other flat surface. Alternatively, in some embodiments, the sensor set 920 is positioned on a surface opposite the multi-touch input surface 902 (e.g., a back surface). The one or more sensors of the sensor set 920 are discussed in detail below.

The side view 925 of the HIPD 900 shows the sensor set 920 and camera 914B. The sensor set 920 includes one or more cameras 922A and 922B, a depth projector 924, an ambient light sensor 928, and a depth receiver 930. In some embodiments, the sensor set 920 includes a light indicator 926. The light indicator 926 can operate as a privacy indicator to let the user and/or those around them know that a camera and/or microphone is active. The sensor set 920 is configured to capture a user's facial expression such that the user can puppet a custom avatar (e.g., showing emotions, such as smiles, laughter, etc., on the avatar or a digital representation of the user). The sensor set 920 can be configured as a side stereo RGB system, a rear indirect Time-of-Flight (iToF) system, or a rear stereo RGB system. As the skilled artisan will appreciate upon reading the descriptions provided herein, the novel HIPD 900 described herein can use different sensor set 920 configurations and/or sensor set 920 placement.

In some embodiments, the HIPD 900 includes one or more haptic devices 971 (FIG. 9B; e.g., a vibratory haptic actuator) that are configured to provide haptic feedback (e.g., kinesthetic sensation). The sensors 951, and/or the haptic devices 971 can be configured to operate in conjunction with multiple applications and/or communicatively coupled devices including, without limitation, wearable devices, health monitoring applications, social media applications, game applications, and artificial reality applications (e.g., the applications associated with artificial reality).

The HIPD 900 is configured to operate without a display. However, in optional embodiments, the HIPD 900 can include a display 968 (FIG. 9B). The HIPD 900 can also income one or more optional peripheral buttons 967 (FIG. 9B). For example, the peripheral buttons 967 can be used to turn on or turn off the HIPD 900. Further, the HIPD 900 housing can be formed of polymers and/or elastomer elastomers. The HIPD 900 can be configured to have a non-slip surface to allow the HIPD 900 to be placed on a surface without requiring a user to watch over the HIPD 900. In other words, the HIPD 900 is designed such that it would not easily slide off surfaces. In some embodiments, the HIPD 900 include one or magnets to couple the HIPD 900 to another surface. This allows the user to mount the HIPD 900 to different surfaces and provide the user with greater flexibility in use of the HIPD 900.

As described above, the HIPD 900 can distribute and/or provide instructions for performing the one or more tasks at the HIPD 900 and/or a communicatively coupled device. For example, the HIPD 900 can identify one or more back-end tasks to be performed by the HIPD 900 and one or more front-end tasks to be performed by a communicatively coupled device. While the HIPD 900 is configured to offload and/or handoff tasks of a communicatively coupled device, the HIPD 900 can perform both back-end and front-end tasks (e.g., via one or more processors, such as CPU 977; FIG. 9B). The HIPD 900 can, without limitation, can be used to perform augmenting calling (e.g., receiving and/or sending 3D or 2.5D live volumetric calls, live digital human representation calls, and/or avatar calls), discreet messaging, 6DoF portrait/landscape gaming, AR/VR object manipulation, AR/VR content display (e.g., presenting content via a virtual display), and/or other AR/VR interactions. The HIPD 900 can perform the above operations alone or in conjunction with a wearable device (or other communicatively coupled electronic device).

FIG. 9B shows block diagrams of a computing system 940 of the HIPD 900, in accordance with some embodiments. The HIPD 900, described in detail above, can include one or more components shown in HIPD computing system 940. The HIPD 900 will be understood to include the components shown and described below for the HIPD computing system 940. In some embodiments, all, or a substantial portion of the components of the HIPD computing system 940 are included in a single integrated circuit. Alternatively, in some embodiments, components of the HIPD computing system 940 are included in a plurality of integrated circuits that are communicatively coupled.

The HIPD computing system 940 can include a processor (e.g., a CPU 977, a GPU, and/or a CPU with integrated graphics), a controller 975, a peripherals interface 950 that includes one or more sensors 951 and other peripheral devices, a power source (e.g., a power system 995), and memory (e.g., a memory 978) that includes an operating system (e.g., an operating system 979), data (e.g., data 988), one or more applications (e.g., applications 980), and one or more modules (e.g., a communications interface module 981, a graphics module 982, a task and processing management module 983, an interoperability module 984, an AR processing module 985, a data management module 986, a disparity correction module 987 (analogous to the disparity correction modules 786A, 786B, 856A and 856B; FIGS. 7B and 8C), etc.). The HIPD computing system 940 further includes a power system 995 that includes a charger input and output 996, a PMIC 997, and a battery 998, all of which are defined above.

In some embodiments, the peripherals interface 950 can include one or more sensors 951. The sensors 951 can include analogous sensors to those described above in reference to FIG. 7B. For example, the sensors 951 can include imaging sensors 954, (optional) EMG sensors 956, IMUs 958, and capacitive sensors 960. In some embodiments, the sensors 951 can include one or more pressure sensor 952 for sensing pressure data, an altimeter 953 for sensing an altitude of the HIPD 900, a magnetometer 955 for sensing a magnetic field, a depth sensor 957 (or a time-of flight sensor) for determining a difference between the camera and the subject of an image, a position sensor 959 (e.g., a flexible position sensor) for sensing a relative displacement or position change of a portion of the HIPD 900, a force sensor 961 for sensing a force applied to a portion of the HIPD 900, and a light sensor 962 (e.g., an ambient light sensor) for detecting an amount of lighting. The sensors 951 can include one or more sensors not shown in FIG. 9B.

Analogous to the peripherals described above in reference to FIGS. 7B, the peripherals interface 950 can also include an NFC component 963, a GPS component 964, an LTE component 965, a Wi-Fi and/or Bluetooth communication component 966, a speaker 969, a haptic device 971, and a microphone 973. As described above in reference to FIG. 9A, the HIPD 900 can optionally include a display 968 and/or one or more buttons 967. The peripherals interface 950 can further include one or more cameras 970, touch surfaces 972, and/or one or more light emitters 974. The multi-touch input surface 902 described above in reference to FIG. 9A is an example of touch surface 972. The light emitters 974 can be one or more LEDs, lasers, etc. and can be used to project or present information to a user. For example, the light emitters 974 can include light indicators 912 and 926 described above in reference to FIG. 9A. The cameras 970 (e.g., cameras 914A, 914B, and 922 described above in FIG. 9A) can include one or more wide angle cameras, fish-eye cameras, spherical cameras, compound eye cameras (e.g., stereo and multi cameras), depth cameras, RGB cameras, ToF cameras, RGB-D cameras (depth and ToF cameras), and/or other available cameras. Cameras 970 can be used for SLAM; 6 DoF ray casting, gaming, object manipulation, and/or other rendering; facial recognition and facial expression recognition, etc.

Similar to the watch body computing system 760 and the wearable band computing system 730 described above in reference to FIG. 7B, the HIPD computing system 940 can include one or more haptic controllers 976 and associated componentry (e.g., haptic devices 971) for providing haptic events at the HIPD 900.

Memory 978 can include high-speed random-access memory and/or non-volatile memory, such as one or more magnetic disk storage devices, flash memory devices, or other non-volatile solid-state memory devices. Access to the memory 978 by other components of the HIPD 900, such as the one or more processors and the peripherals interface 950, can be controlled by a memory controller of the controllers 975.

In some embodiments, software components stored in the memory 978 include one or more operating systems 979, one or more applications 980, one or more communication interface modules 981, one or more graphics modules 982, and one or more data management modules 986, which are analogous to the software components described above in reference to FIG. 7B. The software components stored in the memory 978 can also include the disparity correction module 987 (analogous to the disparity correction modules 786A, 786B, 856A and 856B; FIGS. 7B and 8C), which is configured to perform the features described above in reference to FIGS. 1-5.

In some embodiments, software components stored in the memory 978 include a task and processing management module 983 for identifying one or more front-end and back-end tasks associated with an operation performed by the user, performing one or more front-end and/or back-end tasks, and/or providing instructions to one or more communicatively coupled devices that cause performance of the one or more front-end and/or back-end tasks. In some embodiments, the task and processing management module 983 uses data 988 (e.g., device data 990) to distribute the one or more front-end and/or back-end tasks based on communicatively coupled devices' computing resources, available power, thermal headroom, ongoing operations, and/or other factors. For example, the task and processing management module 983 can cause the performance of one or more back-end tasks (of an operation performed at communicatively coupled AR device 800) at the HIPD 900 in accordance with a determination that the operation is utilizing a predetermined amount (e.g., at least 70%) of computing resources available at the AR device 800.

In some embodiments, software components stored in the memory 978 include an interoperability module 984 for exchanging and utilizing information received and/or provided to distinct communicatively coupled devices. The interoperability module 984 allows for different systems, devices, and/or applications to connect and communicate in a coordinated way without user input. In some embodiments, software components stored in the memory 978 include an AR module 985 that is configured to process signals based at least on sensor data for use in an AR and/or VR environment. For example, the AR processing module 985 can be used for 3D object manipulation, gesture recognition, facial and facial expression, recognition, etc.

The memory 978 can also include data 988, including structured data. In some embodiments, the data 988 can include profile data 989, device data 990 (including device data of one or more devices communicatively coupled with the HIPD 900, such as device type, hardware, software, configurations, etc.), sensor data 991, media content data 992, application data 993, and disparity correction data 994 (analogous to the disparity correction data 792A, 792B, and 865; FIGS. 7B and 8C), which stores data related to the performance of the features described above in reference to FIGS. 1-5.

It should be appreciated that the HIPD computing system 940 is an example of a computing system within the HIPD 900, and that the HIPD 900 can have more or fewer components than shown in the HIPD computing system 940, combine two or more components, and/or have a different configuration and/or arrangement of the components. The various components shown in HIPD computing system 940 are implemented in hardware, software, firmware, or a combination thereof, including one or more signal processing and/or application-specific integrated circuits.

The techniques described above in FIG. 9A-9B can be used with any device used as a human-machine interface controller. In some embodiments, an HIPD 900 can be used in conjunction with one or more wearable devices such as a head-wearable device (e.g., AR device 800 and VR device 810) and/or a wrist-wearable device 700 (or components thereof). In some embodiments, an HIPD 900 can also be used in conjunction with a wearable garment, such as smart textile-based garment 652 (FIG. 6D-1).

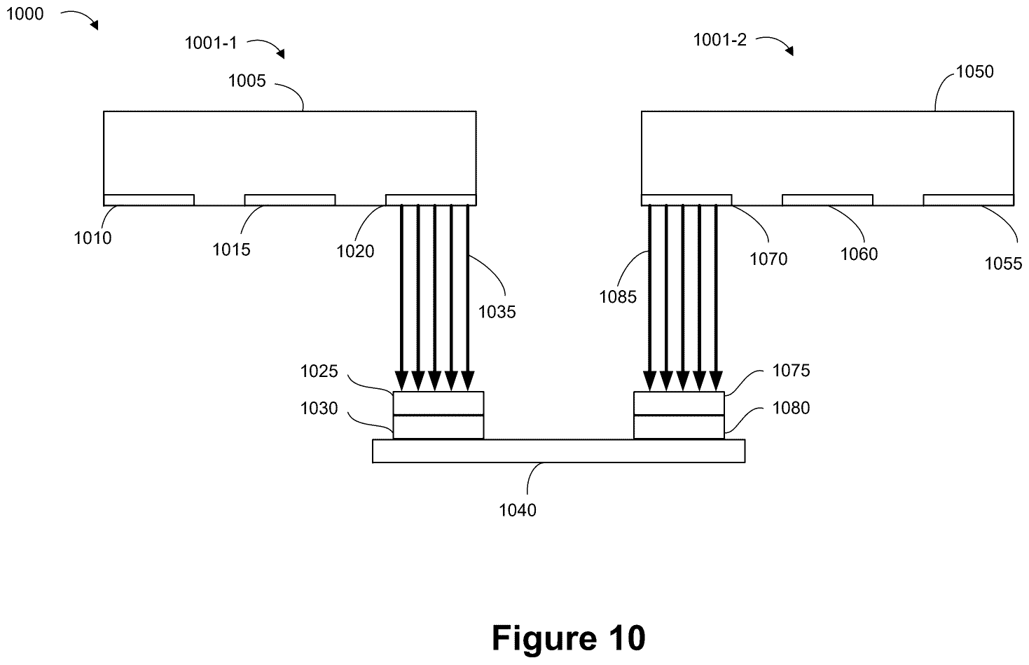

FIG. 10 shows an example disparity sensing system, in accordance with some embodiments. The disparity sensing system 1000 can be implemented by AR glasses (e.g., AR device 800 as described in FIG. 8A) to detect and correct optical disparities between images projected by the binocular displays. For example, the disparity sensing system detects an optical disparity between the two binocular displays of the AR glasses arising from mechanical and/or optical misalignments between one or more components of the display assemblies and/or projection assemblies. The disparity sensing system 1000 can include a disparity sensing assembly 1001-1 (e.g., left disparity sensing assembly) and a disparity sensing assembly 1001-2 (e.g., right disparity sensing assembly). Each disparity sensing assembly (e.g., 1001-1, 1001-2) includes an optical sensor (e.g., optical sensor 1005, optical sensor 1050, waveguide 106-1, or waveguide 106-2 of FIG. 1), a holographic optical element (e.g., holographic optical element 1025 or holographic optical element 1075), a light detector (e.g., photodetector 1030 or photodetector 1080), and one or more supporting components (e.g., rigid substrate 1040). Each optical sensor includes at least one in-coupling optical element (e.g., in-coupler 1010 or in-coupler 1055), at least one projecting coupler (e.g., projecting coupler 1015 or projecting coupler/out-coupling display element 1060), and/or at least one out-coupling optical element (e.g., out-coupler 1020 or out-coupler 1070). For example, the disparity sensing assembly 1001-1 includes the optical sensor 1005, the holographic optical element 1025, and the light detector 1030. For example, the disparity sensing assembly 1001-1 includes the optical sensor 1005, the holographic optical element 1025, and the light detector 1030.

In some embodiments, the holographic optical element 1025 is positionally fixed relative to a first display and the holographic optical element 1075 is positionally fixed relative to a second display. In some embodiments, the holographic optical element 1025 is positionally fixed relative to the first optical sensor (e.g., the waveguide 106-1 of FIG. 1) and the holographic optical element 1075 is positionally fixed relative to the second optical sensor (e.g., waveguide 106-2 of FIG. 1). In some embodiments, the holographic optical element 1025 is positionally fixed relative to the first display and the light detector 1030. In some embodiments, the holographic optical element 1075 is positionally fixed relative to the second display and the light detector 1080. The light detector 1030 and the light detector 1080 are positionally fixed on a top surface of the same rigid substrate 1040 that maintains an alignment of the disparity sensing system 1000 with one or more components of the frame of the artificial-reality glasses.

In some embodiments, each of the holographic optical element 1025 and the holographic optical element 1075 is a planar optical component that transforms one or more properties of incident light (e.g., wavefront, phase, polarization, etc.). For example, the holographic optical elements mimic the transformation properties of a lens in a substantially reduced form factor, in a light weight, and at a low cost to provide desired focusing and/or transformation of incident light. In some embodiments, the holographic optical elements have a minimal height profile (e.g., greater than 0.1 mm, 0.5 mm, 0.7 mm, 1 mm, or 1.05 mm and less than 2 mm, etc.) enabling easier and compact integration into the disparity sensing assembly. Additionally, the optical transformation properties of holographic elements can be independent of a supporting substrate on which the elements are mounted providing flexibility in the selection of substrate materials. In some embodiments, a first portion of the guided optical mode(s) of the optical sensor(s) (e.g., 1005, 1050) is incident onto the holographic optical element(s) (e.g., 1025 and 1075). The holographic optical element(s) transmits a second portion of the incident light toward the respective light detector (e.g., 1030, 1080). In some embodiments, the holographic optical elements are light focusing elements. In some embodiments, the holographic optical elements are optical filters that transmit a predefined range of wavelengths and light focusing elements that focus the predefined range of wavelengths onto the respective light detectors. The predefined range of wavelengths can be selected based on the color channels of the projector(s) and display engine(s), and an analysis of angular variations of focus spot size(s) from the light detector(s).

The holographic optical element focuses the second portion of the incident light to form a focused light spot on the corresponding light detector. For example, the holographic optical element 1025 transforms a portion of the incident planar wave 1035 into a first focused spot on the light detector 1030. As another example, the holographic optical element 1075 transforms a portion of the incident planar wave 1085 into a second focused spot on the light detector 1080. A comparison of the first spot size and the second spot size provides estimations of tip, tilt, mechanical, and/or optical misalignments between the display assembly 1001-1 and the display assembly 1001-2. For example, positional and/or intensity variations between the two focused light spots corresponding to each light detector enable tracking of angular movement between the two displays. The positional and/or intensity deviations are used to determine and/or calibrate the disparities, and based on these disparities, images presented by the displays are updated such that misalignment between images is substantially reduced. In addition, displays of artificial-reality glasses units are calibrated during manufacturing using the display disparity systems to ensure that alignment between displays falls within specifications.

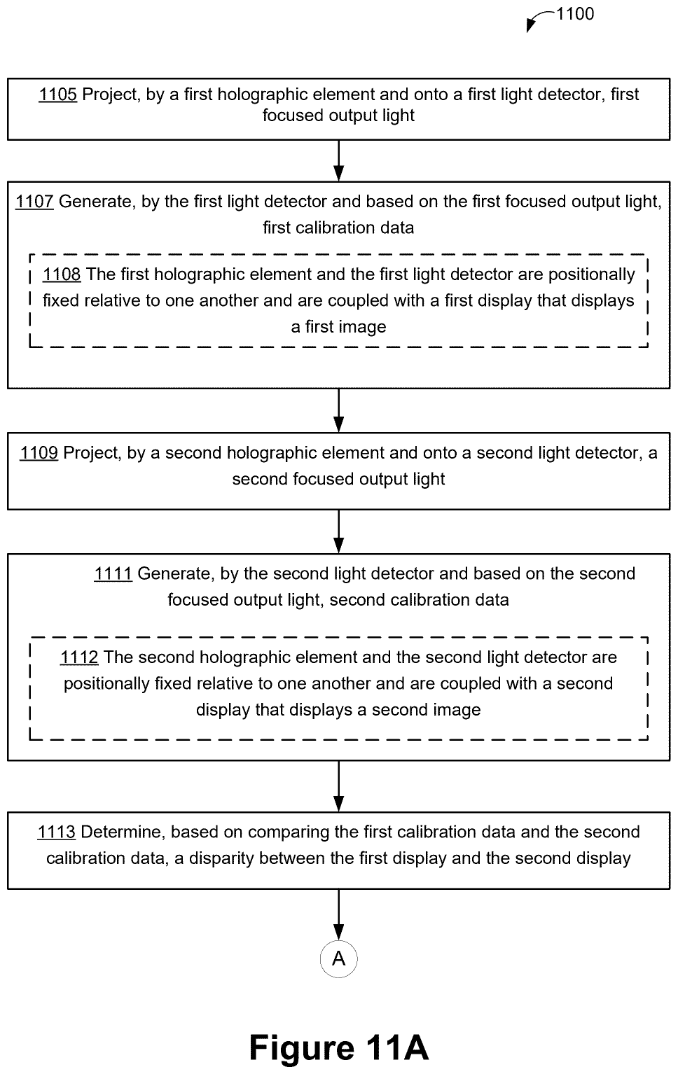

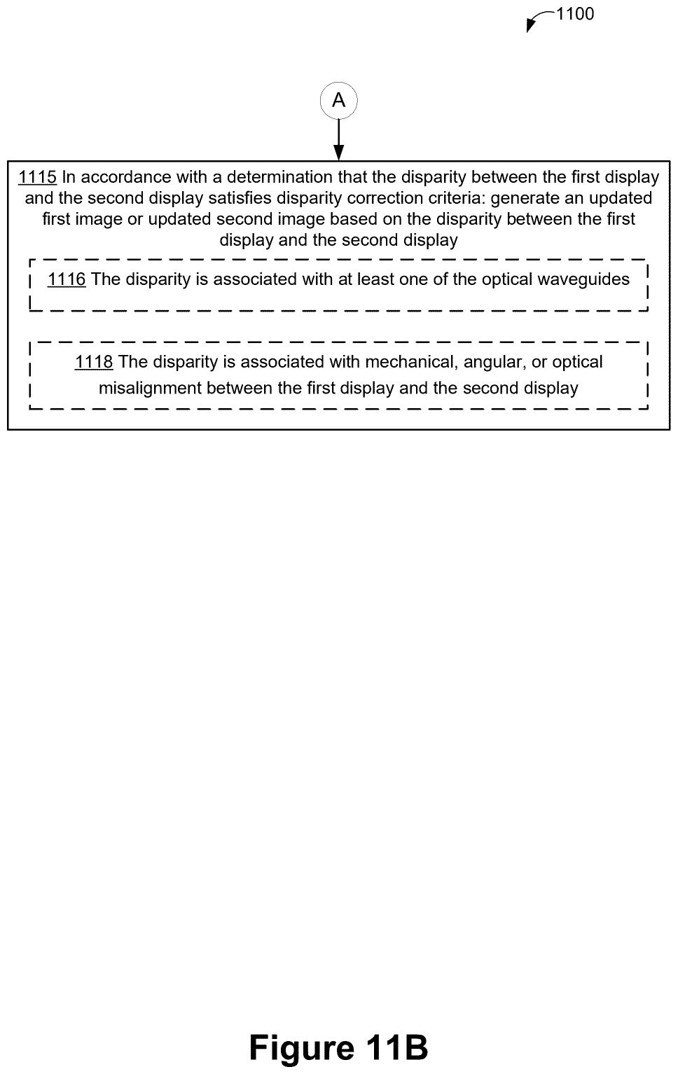

FIGS. 11A and 11B illustrate a flow diagram of an example method 1100 of disparity correction between displays of AR glasses, in accordance with some embodiments. In some embodiments, the flow diagram of FIGS. 11A and 11B can be used to correct disparity between displays (e.g., the optical sensor 1005 and the optical sensor 1050) based on a display disparity system described above in reference to FIG. 10. Operations (e.g., steps) of the method 1100 can be performed by one or more processors (e.g., central processing unit and/or microcontroller unit) of a head-wearable device (e.g., AR glasses or a VR headset) or a system including the head-wearable device and at least one other communicatively coupled device (e.g., a handheld intermediary processing device 900, a server 630, a computer 640, a mobile device 650, and/or other electronic devices described above in reference to FIG. 6A). At least some of the operations shown in FIG. 11 correspond to instructions stored in a computer memory or computer-readable storage medium (e.g., storage, random-access memory, and/or other types of memory; e.g., memory 850 (FIG. 8C)). Operations of the method 1100 can be performed by a single device alone (e.g., the head-wearable device) or in conjunction with one or more processors and/or hardware components of another communicatively coupled device (e.g., a handheld intermediary processing device 900) and/or instructions stored in memory or a computer-readable medium of the other device communicatively coupled to the system. In some embodiments, the various operations of the methods described herein are interchangeable and/or optional, and respective operations of the methods are performed by any of the aforementioned devices, systems, or combination of devices and/or systems. For convenience, the method operations will be described below as being performed by particular component or device, but should not be construed as limiting the performance of the operation to the particular device in all embodiments.

(F1) The method 1100 includes projecting (1105), by a first holographic element and onto a first light detector, a first focused output light, and generating (1107), by the first light detector and based on the first focused output light, first calibration data. The first holographic element and the first light detector are positionally fixed relative to one another and are coupled with a first display that displays a first image. The method includes projecting (1109), by a second holographic element and onto a second light detector, a second focused output light, and generating (1111), by the second light detector and based on the second focused output light, second calibration data. (1112) The second holographic element and the second light detector are positionally fixed relative to one another and are coupled with a second display that displays a second image. The method determines (1113), based on comparing the first calibration data and the second calibration data, a disparity between the first display and the second display; and in accordance with a determination (1115) that the disparity between the first display and the second display satisfies disparity correction criteria: generates an updated first image or updated second image based on the disparity between the first display and the second display. In some embodiments, (1116) the disparity is associated with at least one of the optical waveguides and/or (1117) with mechanical, angular, or optical misalignment(s) between the first display and the second display.

(F2) In some embodiments of F1, the method 1100 further receives, by the first holographic element and from a first optical sensor, first non-focused light, and receives, by the second holographic element and from a second optical sensor, second non-focused light. For example, as described above in reference to FIG. 10, the holographic optical element 1025 receives, from the optical sensor 1005, non-focused light/planar electromagnetic waves 1035. As another example, as described above in reference to FIG. 10, the holographic optical element 1075 receives, from the optical sensor 1050, non-focused light/planar electromagnetic waves 1085.

(F3) In some embodiments of F1-F2, the first optical sensor and the second optical sensor are both optical waveguides with at least one optical coupling element. For example, as described above in reference to FIG. 10, the optical sensor 1005 is a display waveguide with an in-coupling optical element 1010, an out-coupling display element/the projecting coupler 1015, and an out-coupling disparity element 1020. As another example, as described above in reference to FIG. 10, the optical sensor 1050 is a display waveguide with an in-coupling optical element 1055, an out-coupling display element 1060, and an out-coupling disparity element 1070.

(F4) In some embodiments of F1-F3, the first non-focused light and the second non-focused light are planar electromagnetic waves. For example, as described above in reference to FIG. 10, the out-coupler elements 1020 and 1070 out-couple a portion of the display images, as planar electromagnetic waves 1035 and 1085, toward the holographic optical elements 1025 and 1075. In some embodiments, the out-coupled portion of the display images are electromagnetic wavefronts with varying intensities and/or polarizations.

(F5) In some embodiments of F1-F4, the first holographic element and the second holographic element are configured to transform planar electromagnetic waves into the first focused light and the second focused light, respectively. For example, as described above in reference to FIG. 10, the holographic optical element 1025 and the holographic optical element 1075 transform the electromagnetic waves from the out-couplers 1020 and 1070 into focused beams that form light spots onto the corresponding light detectors 1030 and 1080.

(F6) In some embodiments of F1-F5, the disparity is associated with at least one of the first optical sensor and the second optical sensor. For example, variations between the optical sensor 1005 and the optical sensor 1050 as described above with respect to FIG. 10 can cause propagation-related variations between the images projected out of the optical sensors and toward the eyes of the wearer of the artificial-reality glasses.

(F7) In some embodiments of F1-F6, the disparity is associated with mechanical, angular, and/or optical misalignment between the first display and the second display. For example, as described above in reference to FIG. 10, mechanical and/or optical misalignment(s) between one or more components of the first display assembly (e.g., 806-1) and/or the display assembly (e.g., 806-2) can cause disparities in the images projected to the user of the artificial-reality glasses. As another example, as described above in reference to FIG. 10, fabrication and/or optical coupling differences between the optical sensor 1005 and the optical sensor 1050 can cause optical disparities in the images projected to the user of the artificial-reality glasses.

(F8) In some embodiments of F1-F7, each of the first light detector and the second light detector is a photodetector (e.g., four-quadrant photodetector).

(F9) In some embodiments of F1-F8, the first light detector and the second light detector are positioned on the same rigid substrate at a fixed distance. For example, the left photodetector/light detector 1030 and the right photodetector/light detector 1080 of FIG. 10 are positioned on a top surface of a rigid substrate 1040.

(F10) In some embodiments of F1-F9, the first light detector and the second light detector are positionally fixed relative to one another at a fixed distance. For example, the left photodetector/light detector 1030 and the right photodetector/light detector 1080 of FIG. 10 are positioned on the top surface of the rigid substrate 1040 at a fixed distance from one another.

(F11) In some embodiments of F1-F10, the first optical sensor and the second optical sensor are positionally fixed relative to one another. For example, the left optical sensor (e.g., the optical sensor 1005) and the right optical sensor (e.g., the optical sensor 1050) of FIG. 10 are positionally fixed relative to one another.

(F12) In some embodiments of F1-F11, the comparing of the first calibration data and the second calibration data is based on prestored disparity calibration data. For example, the prestored calibration data is based on a left display disparity sensor (e.g., display disparity assembly 1001-1) and a right display disparity sensor (e.g., display disparity assembly 1001-2) for a plurality of artificial-reality glasses with varying frame and/or display sizes and/or specifications.

(F13) In some embodiments of F1-F12, the disparity between the first display and the second display is associated with tip or tilt misalignment between the first display and the second display. For example, bending, rotational, and/or torsional stressors on the artificial-reality glasses cause mechanical and/or optical misalignments between one or more components of the projector and display assemblies as described above with respect to FIGS. 1 and 10.

(G1) In accordance with some embodiments, a system that includes an artificial-reality headset (also referred to as a head-wearable device) and at least one electronic device, and the system is configured to perform operations corresponding to any of F1-F13.

(H1) In accordance with some embodiments, a non-transitory computer-readable storage medium including instructions that, when executed by a computing device in communication with an artificial-reality headset, cause the computer device to perform operations corresponding to any of F1-F13.

(I1) In accordance with some embodiments, an artificial-reality headset configured in accordance with FIG. 10 and configured to perform or cause the performance of the operations corresponding to any of F1-F13.

(J1) In accordance with some embodiments, a means for operating an artificial reality headset, means for performing operations that correspond to any of F1-F13.

(K1) In accordance with some embodiments, a method of assembly includes (i) positionally fixing a first holographic element and a first light detector relative to one another and coupling the first holographic element and the first light detector to a first display to display a first image; (ii) positionally fixing a second holographic element and a second light detector relative to one another and coupling the second holographic element and the second light detector to a second display to display a second image; and (iii) coupling the first display and the second display to artificial-reality glasses, wherein the artificial-reality glasses are configured to perform disparity correction by using the method recited in any one of claims F1-F13.

Any data collection performed by the devices described herein and/or any devices configured to perform or cause the performance of the different embodiments described above in reference to any of the Figures, hereinafter the “devices,” is done with user consent and in a manner that is consistent with all applicable privacy laws. Users are given options to allow the devices to collect data, as well as the option to limit or deny collection of data by the devices. A user is able to opt in or opt out of any data collection at any time. Further, users are given the option to request the removal of any collected data.

It will be understood that, although the terms “first,” “second,” etc., may be used herein to describe various elements, these elements should not be limited by these terms. These terms are only used to distinguish one element from another.

The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” can be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

What is claimed is:

1. An artificial-reality headset, comprising:
a first holographic element positionally fixed relative to a first light detector, wherein the first holographic element projects first focused light onto the first light detector;
a first display coupled to the first holographic element, wherein the first display causes display of a first image;
a second holographic element positionally fixed relative to a second light detector, wherein the second holographic element projects second focused light onto the second light detector;
a second display coupled to the second holographic element, wherein the second display causes display of a second image; and
at least one display engine configured to:
receive respective calibration data from the first light detector and the second light detector;
determine, based on comparing the respective calibration data, a disparity between the first display and the second display; and
in accordance with a determination that the disparity between the first display and the second display satisfies disparity correction criteria, generate an updated first image or updated second image based on the disparity between the first display and the second display.

2. The artificial-reality headset of claim 1, further comprising:
a first optical sensor configured to project first non-focused light onto the first holographic element; and
a second optical sensor configured to project second non-focused light onto the second holographic element, wherein the first non-focused light and the second non-focused light are planar electromagnetic waves.

3. The artificial-reality headset of claim 2, wherein the first holographic element and the second holographic element are configured to transform the planar electromagnetic waves into the first focused light and the second focused light, respectively.

4. The artificial-reality headset of claim 3, wherein the disparity is associated with at least one of the first optical sensor and the second optical sensor.

5. The artificial-reality headset of claim 2, wherein the first optical sensor and the second optical sensor are positionally fixed relative to one another.

6. The artificial-reality headset of claim 1, wherein the disparity is associated with mechanical, angular, or optical misalignment between the first display and the second display.

7. The artificial-reality headset of claim 1, wherein each of the first light detector and the second light detector is a photodetector.

8. The artificial-reality headset of claim 1, wherein the first light detector and the second light detector are positioned on a same rigid substrate at a fixed distance and positionally fixed relative to one another.

9. The artificial-reality headset of claim 1, wherein comparing the respective calibration data is based on prestored disparity calibration data.

10. The artificial-reality headset of claim 1, wherein the disparity between the first display and the second display is associated with tip or tilt misalignment between the first display and the second display.

11. A method of disparity correction in an artificial-reality headset, comprising:
projecting, by a first holographic element and onto a first light detector, first focused light;
generating, by the first light detector and based on the first focused light, first calibration data, wherein the first holographic element and the first light detector are positionally fixed relative to one another and are coupled with a first display that displays a first image;
projecting, by a second holographic element and onto a second light detector, a second focused light;
generating, by the second light detector and based on the second focused light, second calibration data, wherein the second holographic element and the second light detector are positionally fixed relative to one another and are coupled with a second display that displays a second image;
determining, based on comparing the first calibration data and the second calibration data, a disparity between the first display and the second display; and
in accordance with a determination that the disparity between the first display and the second display satisfies disparity correction criteria, generating an updated first image or updated second image based on the disparity between the first display and the second display.

12. The method of claim 11, wherein the method further comprises:
receiving, by the first holographic element and from a first optical sensor, first non-focused light; and
receiving, by the second holographic element and from a second optical sensor, second non-focused light, wherein the first non-focused light and the second non-focused light are planar electromagnetic waves.

13. The method of claim 11, wherein the first holographic element and the second holographic element are configured to transform planar electromagnetic waves into the first focused light and the second focused light, respectively.

14. The method of claim 12, wherein the disparity is associated with at least one of the first optical sensor and the second optical sensor.

15. The method of claim 12, wherein the disparity is associated with mechanical, angular, or optical misalignment between the first display and the second display.

16. The method of claim 11, wherein the first light detector and the second light detector are positioned on a same rigid substrate and positionally fixed relative to one another.

17. The method of claim 12, wherein the first optical sensor and the second optical sensor are positionally fixed relative to one another.

18. The method of claim 11, wherein comparing the first calibration data and the second calibration data is based on prestored disparity calibration data.

19. The method of claim 11, wherein the disparity between the first display and the second display is associated with tip or tilt misalignment between the first display and the second display.

20. A method of assembly, comprising:
positionally fixing a first holographic element and a first light detector relative to one another and coupling the first holographic element and the first light detector to a first display to display a first image;
positionally fixing a second holographic element and a second light detector relative to one another and coupling the second holographic element and the second light detector to a second display to display a second image; and
coupling the first display and the second display to artificial-reality glasses, wherein the artificial-reality glasses are configured to perform disparity correction.
